(19) United States
(12) Patent Application Publication
(10) Pub. No.: US 2013/0225181 A1
(43) Pub. Date: Aug. 29, 2013

(54) MANAGING COMMUNICATION OPERATIONS BASED ON RESOURCE USAGE AND ACCESS TERMINAL CATEGORY

(71) Applicant: QUALCOMM Incorporated, (US)

(72) Inventors: Andrei Dragos Radulescu, San Diego, CA (US); Peerapol Tinnakornsrisuphap, San Diego, CA (US); Farhad Meskat, San Diego, CA (US); Yeliz Tokgoz, San Diego, CA (US); Mehmet Yavuz, San Diego, CA (US)

(73) Assignee: QUALCOMM Incorporated, San Diego, CA (US)

(21) Appl. No.: 13/773,467

(22) Filed: Feb. 21, 2013

Related U.S. Application Data
(60) Provisional application No. 61/603,036, filed on Feb. 24, 2012.

(51) Int. Cl. H04W 36/22

(52) U.S. Cl. CPC H04W 36/22
USPC 455/442; 455/436

(57) ABSTRACT

An access point may handle an access terminal in different ways based on resource usage at the access point and/or based on at least one category associated with the access terminal. This handling of an access terminal by an access point may involve, for example, a reduction or an increase in service, access to specific resources, handout, and long term adjustments. If usage of one or more resources at the access point exceeds a corresponding usage threshold, the access point may reduce the service available to lower priority access terminals and/or increase the service available to higher priority access terminals. In some aspects, access terminals may be handled differently according to the serving access point's bandwidth, capacity, cost, or resource usage regarding backhaul, over-the-air, or other access point resources. In some aspects, access terminals may be handled differently according to a category (or categories) associated with the access terminals.

### CLAIM OF PRIORITY

This application claims the benefit of and priority to commonly owned U.S. Provisional Patent Application No. 61/603,036, filed Feb. 24, 2012, and assigned Attorney Docket No. 121561P1, the disclosure of which is hereby incorporated by reference herein.

### BACKGROUND

1. Field

This application relates generally to wireless communication and more specifically, but not exclusively, to managing communication operations.

2. Introduction

A wireless communication network may be deployed over a defined geographical area to provide various types of services (e.g., voice, data, multimedia services, etc.) to users within that geographical area. In a typical implementation, access points (e.g., corresponding to different cells) are distributed throughout a network to provide wireless connectivity for access terminals (e.g., cell phones) that are operating within the geographical area served by the network.

As the demand for high-rate and multimedia data services rapidly grows, there lies a challenge to implement efficient and robust communication systems with enhanced performance. To supplement conventional network access points (e.g., macro access points), low-power access points (e.g., with transmit power of 20 dBm or less) may be deployed to provide more robust coverage for access terminals. For example, a low-power access point installed in a user's home or in an enterprise environment (e.g., commercial buildings) may provide voice and high speed data service for access terminals supporting cellular radio communication (e.g., CDMA, WCDMA, UMTS, LTE, etc.).

Such low-power access points may be referred to as, for example, femtocells, femto access points, femto nodes, home NodeBs (HNBs), home eNodeBs (HeNBs), access point base stations, picocells, or pico nodes. Typically, such low-power access points connect to the Internet via a broadband connection (e.g., a digital subscriber line (DSL) a router, a cable modem, or some other type of modem) that provides a backhaul link to a mobile operator's network. Thus, for example, low-power access points deployed in user homes provide mobile network access to one or more devices via the broadband connection. For convenience, the discussions that follow may refer to deployments that use femtocells or femto access points. It should be appreciated, however, that these discussions may be generally applicable to any type of low-power access point.

A femtocell may run out of resources such as channel elements, bandwidth, capacity, etc., while serving multiple users. For example, backhaul and/or over-the-air (OTA) bandwidth limits may be reached, all of the channel elements provided by the access point could be used, a data-throttling limit (e.g., a tiered monthly data limit imposed by a service provider) may be reached, and so on. A femtocell may be more likely to run out of resources if the femtocell is an open access femtocell, if the femtocell is a hybrid access femtocell, or if the femtocell is on a camping channel. In these cases, there is a higher likelihood for a larger number of users to be served by the femtocell, thereby increasing the demand on the femtocell. Consequently, there is a need for effective techniques that enable a femtocell to provide appropriate quality of service (QoS) for the users of the femtocell when the femtocell is approaching or hitting a resource limit.

### SUMMARY

A summary of several sample aspects of the disclosure follows. This summary is provided for the convenience of the reader to provide a basic understanding of such aspects and does not wholly define the breadth of the disclosure. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later. For convenience, the term some aspects may be used herein to refer to a single aspect or multiple aspects of the disclosure.

The disclosure relates in some aspects to an access point that handles access terminals in different ways based on resource usage at the access point and/or based on at least one category associated with each of the access terminals. This handling of an access terminal by an access point may involve, for example, one or more of: reduction or increase in service, access to specific resources, handout, denial of service, and long-term adjustments.

In some aspects, access terminals may be handled differently according to the access point's resource usage in terms of bandwidth, capacity, cost, power, user load, memory, CPU cycles, or other usage with respect to backhaul, over-the-air, or other access point resources. For example, an access point may manage communication operations (e.g., initiate handover, control admission, adjust resource allocation, adjust mobility parameters, etc.) for one or more access terminals in a certain way when the access point is approaching or hitting a resource limitation relating to the resource usage parameter(s) specified for that access point.

In some aspects, access terminals may be handled differently according to a category (or categories) associated with the access terminals. For example, an access point may decide how to manage different access terminals (e.g., admit, hand-over, adjust resource allocation, etc.) based on their respective membership, priority, class type, cost of service, traffic type, provisioning, or other access terminal category. Thus, an access point may downgrade, hand-out, or refuse to admit a low priority access terminal to prevent the performance of high priority access terminals from being adversely affected by resource usage of the low priority access terminal. The priority (low versus high) of an access terminal may be indicated based on, for example, one or more of the above categories defined by the operator or in some other manner.

As a specific example of the above, if usage of one or more resources at the access point has reached or is approaching a resource limit, the access point may take steps to reduce the service available to lower priority access terminals and/or increase the service available to higher priority access terminals. These steps may involve, for example: determining how to perform a mobility operation at the access point for the access terminal (e.g., handing-over a lower priority access terminal to another access point, not allowing a lower priority access terminal to be admitted for service at the access point, or adjusting at least one mobility parameter to cause a lower priority access terminal to be more easily (e.g., more quickly) handed-over to another access point); or adjusting at least one resource allocation (e.g., adjusting data allocation, adjusting radio state, adjusting cell coverage, selecting a different user plane attach point, or selecting a different backhaul) to reduce the resources available to a lower priority access terminal and/or to increase the resources available to a higher priority access terminal.

In view of the above, in some aspects, wireless communication in accordance with the teachings herein involves: receiving at least one signal; determining, based on the at least one received signal, whether usage of at least one resource associated with an access point exceeds a usage threshold; determining an identifier of an access terminal; identifying at least one access terminal category assigned to the access terminal identifier; and determining how to perform a mobility operation at the access point for the access terminal based on the identified at least one access terminal category and the determination of whether the usage exceeds the usage threshold.

In some aspects, wireless communication in accordance with the teachings herein involves: receiving at least one signal; determining, based on the at least one received signal, whether usage of at least one resource associated with an access point exceeds a usage threshold; determining an identifier of an access terminal; identifying at least one access terminal category assigned to the access terminal identifier; and selecting a backhaul for the access point based on the identified at least one access terminal category and the determination of whether the usage exceeds the usage threshold.

In some aspects, wireless communication in accordance with the teachings herein involves: receiving at least one signal; determining, based on the at least one received signal, whether usage of at least one resource associated with an access point exceeds a usage threshold; determining an identifier of an access terminal; identifying at least one access terminal category assigned to the access terminal identifier; and determining whether to adjust a data allocation associated with the access point for the access terminal based on the identified at least one access terminal category and the determination of whether the usage exceeds the usage threshold.

### BRIEF DESCRIPTION OF THE DRAWINGS

These and other sample aspects of the disclosure will be described in the detailed description and the claims that follow, and in the accompanying drawings, wherein:

FIG. 1 is a simplified block diagram of a sample embodiment of a communication system;

FIG. 2 is a flowchart of several sample aspects of operations that may be performed in conjunction with handling UEs at a femtocell;

FIG. 3 is a flowchart of several sample aspects of operations that may be performed in conjunction with determining how to perform a mobility operation at an access point;

FIG. 4 is a flowchart of several sample aspects of operations that may be performed in conjunction with selecting a backhaul for an access point;

FIG. 5 is a flowchart of several sample aspects of operations that may be performed in conjunction with determining whether to adjust a data allocation associated with an access point;

FIG. 6 is a flowchart of several sample aspects of operations that may be performed in conjunction with determining whether to hand-over an access terminal;

FIG. 7 is a flowchart of several sample aspects of operations that may be performed in conjunction with determining whether to adjust a resource allocation;

FIG. 8 is a flowchart of several sample aspects of operations that may be performed in conjunction with determining whether to adjust a mobility parameter;

FIG. 9 is a flowchart of several sample aspects of operations that may be performed in conjunction with determining whether to admit an access terminal;

FIG. 10 is a simplified block diagram of several sample aspects of components that may be employed in communication nodes;

FIG. 11 is a simplified diagram of a wireless communication system;

FIG. 12 is a simplified diagram of a wireless communication system including femto nodes;

FIG. 13 is a simplified diagram illustrating coverage areas for wireless communication;

FIG. 14 is a simplified block diagram of several sample aspects of communication components; and

FIGS. 15-17 are simplified block diagrams of several sample aspects of apparatuses configured to manage communication operations as taught herein.

In accordance with common practice, the various features illustrated in the drawings may not be drawn to scale. Accordingly, the dimensions of the various features may be arbitrarily expanded or reduced for clarity. In addition, some of the drawings may be simplified for clarity. Thus, the drawings may not depict all of the components of a given apparatus (e.g., device) or method. Finally, like reference numerals may be used to denote like features throughout the specification and figures.

### DETAILED DESCRIPTION

Various aspects of the disclosure are described below. It should be apparent that the teachings herein may be embodied in a wide variety of forms and that any specific structure, function, or both being disclosed herein is merely representative. Based on the teachings herein one skilled in the art should appreciate that an aspect disclosed herein may be implemented independently of any other aspects and that two or more of these aspects may be combined in various ways. For example, an apparatus may be implemented or a method may be practiced using any number of the aspects set forth herein. In addition, such an apparatus may be implemented or such a method may be practiced using other structure, functionality, or structure and functionality in addition to or other than one or more of the aspects set forth herein. Furthermore, an aspect may comprise at least one element of a claim.

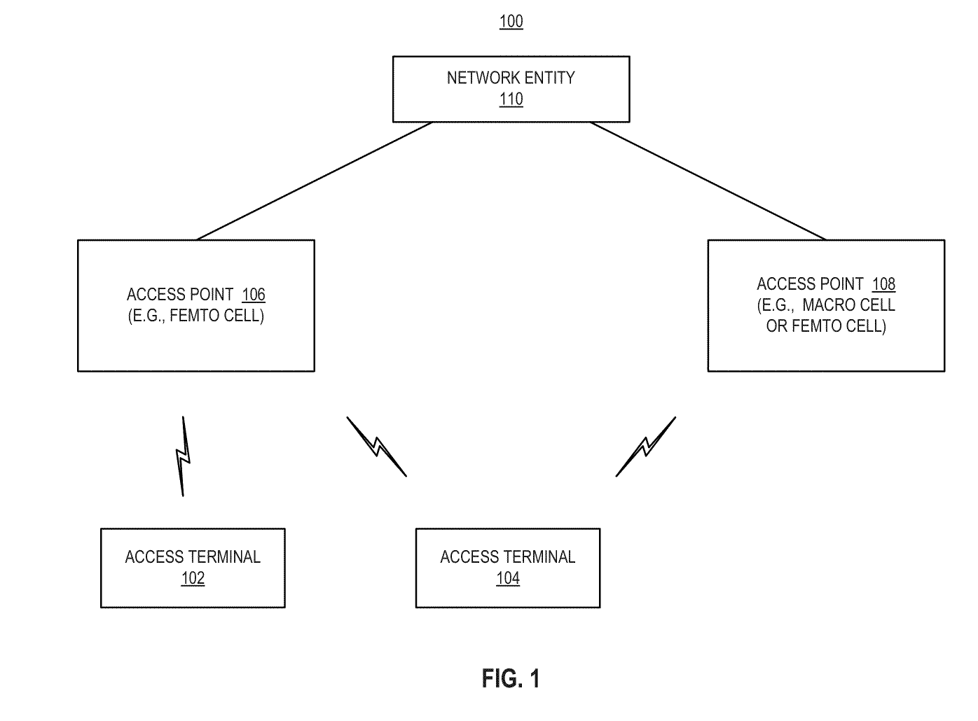

FIG. 1 illustrates several nodes of a sample communication system 100 (e.g., a portion of a communication network). For illustration purposes, various aspects of the disclosure will be described in the context of one or more access terminals, access points, and network entities that communicate with one another. It should be appreciated, however, that the teachings herein may be applicable to other types of apparatuses or other similar apparatuses that are referenced using other terminology. For example, in various implementations access points may be referred to or implemented as base stations, NodeBs, eNodeBs, Home NodeBs, Home eNodeBs, macrocells, femtocells, and so on, while access terminals may be referred to or implemented as user equipment (UEs), mobile stations, and so on.

Access points in the system 100 provide access to one or more services (e.g., network connectivity) for one or more wireless terminals (e.g., access terminals 102 and 104) that may be installed within or that may roam throughout a coverage area of the system 100. For example, at various points in time the access terminal 102 may connect to an access point 106, an access point 108, or some access point in the system 100 (not shown). Similarly, at various points in time the access terminal 104 may connect to the access point 106, the access point 108, or some access point. Each of the access points may communicate with one or more network entities (represented, for convenience, by a network entity 110), including each other (not shown), to facilitate wide area network connectivity.

These network entities may take various forms such as, for example, one or more radio and/or core network entities. Thus, in various implementations the network entities may represent functionality such as at least one of: network management (e.g., via an operation, administration, management, and provisioning entity), call control, session management, mobility management, gateway functions, interworking functions, radio resource management, or some other suitable network functionality. In some aspects, mobility management relates to: keeping track of the current location of access terminals through the use of tracking areas, location areas, routing areas, or some other suitable technique; controlling paging for access terminals; providing access control for access terminals; controlling handover; controlling reselection, and so on. Two of more of these network entities may be co-located and/or two or more of these network entities may be distributed throughout a network.

Certain categories of access terminals may be assigned a higher priority at a given access point than other access terminals. For example, if the access terminal 102 is a member of a group associated with the access point 106 (e.g., a femtocell) and the access terminal 104 is not a member of that group, the access terminal 102 may be given higher priority by the access point 106.

In some implementations, access points (e.g., femtocells) may be configured to support different types of access modes. For example, in an open access mode, an access point may allow any access terminal to obtain any type of service via the access point. In a restricted (or closed) access mode, an access point may only allow authorized access terminals to obtain service via the access point. For example, an access point may only allow access terminals (e.g., so called home access terminals) belonging to a certain subscriber group (e.g., a closed subscriber group (CSG)) to obtain service via the access point. In a hybrid access mode, alien access terminals (e.g., non-home access terminals, non-CSG access terminals) may be given limited access to the access point. For example, a macro access terminal that does not belong to a femtocell's CSG may be allowed to access the femtocell only if sufficient resources are available for all home access terminals currently being served by the femtocell.

If the access point 106 (e.g., a femtocell) is operating in open access mode or hybrid mode, the resources available from the access point 106 could easily run out if there are a large number of access terminals in the immediate vicinity of the access point 106. For example, backhaul bandwidth limits may be reached, all of the channel elements provided by the access point 106 could be used, a data-throttling limit (e.g., a monthly limit imposed by a service provider) may be reached, and so on.

In accordance with the teachings herein, an access point may handle an access terminal in different ways based on resource usage at the access point and/or based on at least one category associated with the access terminal. For example, if usage of one or more resources specified for the access point 106 exceeds a corresponding usage threshold (e.g., indicating that a resource limit is being approached or has been reached), the access point 106 may reduce the service available to any lower priority access terminals (e.g., the access terminal 104). Here, it should be appreciated that a test of whether usage exceeds a threshold is equivalent in some aspect to determining whether usage is greater than or equal to another (slightly different) threshold.

The reduction in service referred to above may take various forms. For example, such a reduction in service may include handing-over a lower priority access terminal to another access point (e.g., the access point 108), not allowing a lower priority access terminal to be admitted for service at the access point 106, adjusting cell coverage of the access point 106 to reduce the number of access terminals being served by the access point 106, adjusting at least one mobility parameter to cause a lower priority access terminal to be more easily (e.g., more quickly) handed-over to another access point (e.g., a macrocell or a neighboring femtocell), adjusting at least one resource allocation to reduce the resources available to a lower priority access terminal, and so on.

Thus, in some aspects, a femtocell manages resources (e.g., initiates handover, adjusts resource allocation or mobility parameters, controls admission, etc.) for one or more users when the femtocell is approaching or hitting a resource limitation. This limitation may relate to one or more resources such as: channel elements, backhaul bandwidth, bandwidth cost, transmit power, load, memory, CPU cycles, over-the-air capacity, etc.

Moreover, the femtocell may decide how to manage (e.g., hand-over, etc.) users based on one or more categories associated with the users. For example, a femtocell may downgrade or hand-out a low priority user to make sure that the performance of high priority users is not impacted. Here, the users may be wireless or wired access terminals that share resources (e.g., bandwidth, throttling threshold, capacity, etc.) of the access point. A low versus high priority user may be indicated based on, for example, ownership of the femtocell, payment plan, traffic type, provisioning or other criteria that may be decided, for example, by the operator.

The decision on when or how to manage (e.g., downgrade, upgrade, hand-over, retain, admit, reject) a user may be based on instantaneous resource availability, long-term statistics, predictions, or other suitable resource criteria. The resources considered may be those of a serving access point (or potential serving access point) and/or of neighboring access points (e.g., potential target access points). This information may be obtained by the femtocell via, for example, Network Listen operations, UE reports, backhaul messaging, configuration by user or operator, or hard coded information. In some cases, this information comprises assumed consumption characteristics, configured consumption characteristics, or learned consumption characteristics.

Resource management also may involve in some aspects resource reservation for high priority access terminals. For example, a certain percentage of an available resource may be set aside for the high priority access terminals, whereby any lower priority access terminals will only be allocated resources from the unreserved pool of resources.

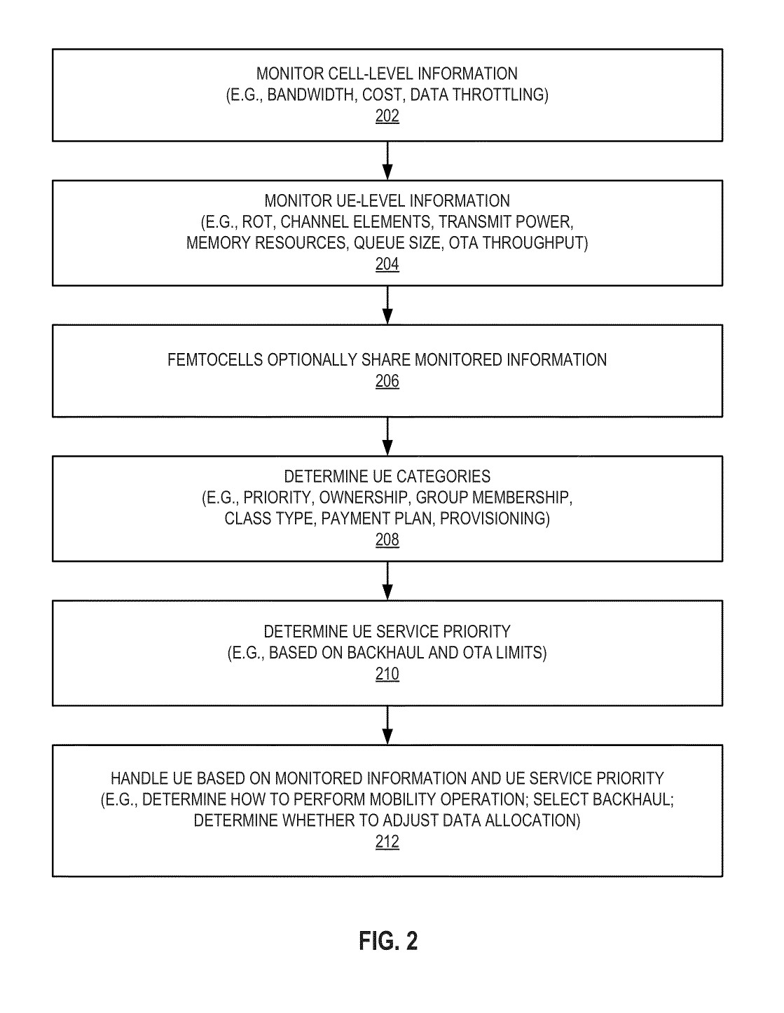

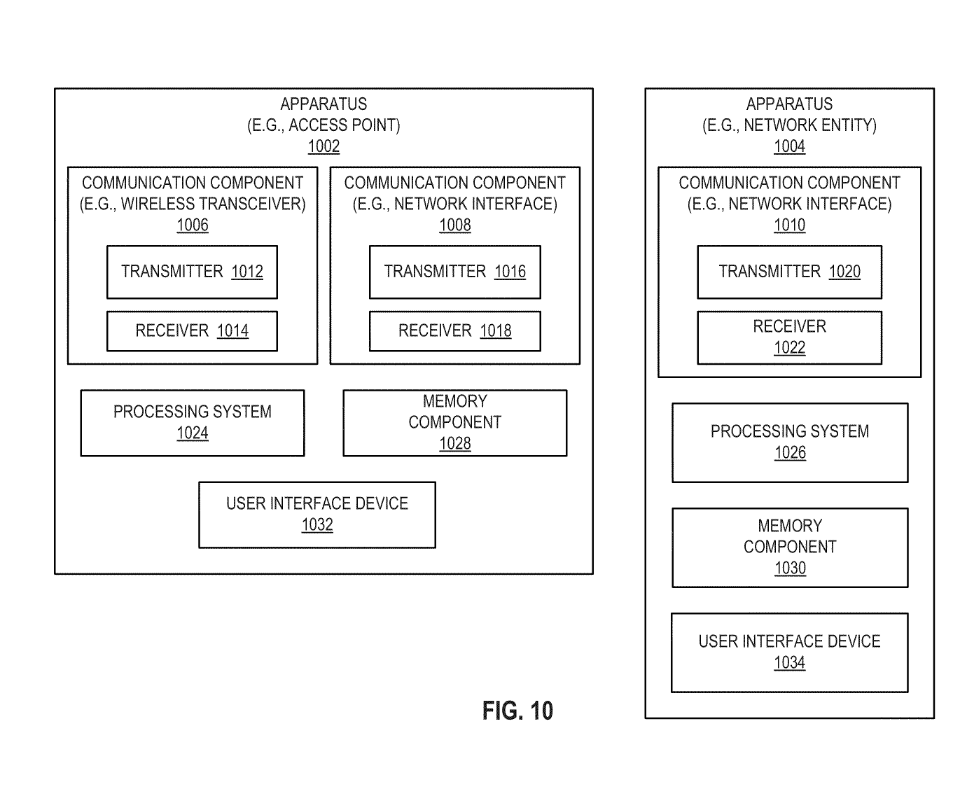

With the above overview in mind, various details relating to handling access terminals based on resource usage and access terminal categories will now be treated with reference to the flowchart of FIG. 2. For convenience, the operations of FIG. 2 (or any other operations discussed or taught herein) may be described as being performed by specific components (e.g., the components of FIG. 1 or FIG. 10). It should be appreciated, however, that these operations may be performed by other types of components and may be performed using a different number of components. It also should be appreciated that one or more of the operations described herein may not be employed in a given implementation.

For purposes of illustration, FIG. 2 describes a scenario where a femtocell provides service to UEs. In addition, the operations of FIG. 2 are described as being performed by a femtocell. It should be appreciated, however, that the concepts that follow are applicable to other scenarios and devices.

As represented by block 202, the femtocell monitors cell level-related information that the femtocell will use to determine how to handle access terminals. Several examples of quantities (e.g., resource usage information) that may be monitored by an access point at the cell level follow. The quantities may be instantaneous quantities, averages over a period of time, or some other metric.

In some implementations, the cell-level information is backhaul bandwidth-related information. For example, the allocated backhaul bandwidth and the used backhaul bandwidth may be tracked to determine the available backhaul bandwidth. In some aspects, the backhaul may refer to a femtocell's connection to an operator's network. In other aspects, the backhaul may refer to the femtocell's connection to networks or network elements that may be outside the operator's network. The backhaul bandwidth information may be monitored or otherwise derived in various ways.

In some implementations, the backhaul bandwidth information may be derived from observations (e.g., of the maximum bandwidth) over a set period of time. In some aspects, this information may depend on the femtocell's location in the user network. For example, depending on whether the femtocell includes the modem for communicating with the operator's network, the monitored information may correspond to the bandwidth for all users (e.g., including Wi-Fi users, if applicable) or the bandwidth only for that femtocell's users.

In some implementations, the backhaul bandwidth information is derived from verification by the femtocell against a designated network server (or server pool). Thus, the monitoring may involve actual measurements of bandwidth. To this end, a femtocell may conduct ping tests or some other suitable bandwidth tests.

In some implementations, the backhaul bandwidth information is derived from evaluation of round-trip time (RTT) and/or frame error rate (FER) of uncached packets against servers in the network that are close to the femtocell. For example, this evaluation may be made with respect to a Home NodeB gateway for a Home NodeB (e.g., femtocell).

In some implementations, the backhaul bandwidth information is derived from signaling received from other devices in the network. For example, a femtocell may sniff Ethernet packets being sent to or received from a cable modem.

Backhaul bandwidth information may be acquired over a period of time to obtain information regarding usage pattern variations over time. For example, the monitoring may be time-dependent on a cyclic basis (e.g., 24 hours, 7 days, etc.).

In some implementations, reserved backhaul bandwidth information is obtained. For example, a guaranteed bandwidth may be obtained from an entity that specified the guaranteed bandwidth (e.g., specified by a network operator or other provider, or by user input).

In the discussions that follow, uplink backhaul bandwidth may be referred to as BW_{UL}, while downlink backhaul bandwidth may be referred to as BW_{DL}.

In some implementations, the cell-level information monitored at block 202 relates to the financial cost to the femtocell owner and/or to the operator as a result of operating the femtocell. In some aspects, this cost may be related to the amount of traffic at the femtocell.

The financial cost information may be obtained in various ways. For example, this information is obtained from user input in some cases. As another example, this information is preconfigured by an operator, an Internet Service Provider (ISP), an Original Equipment Manufacturer (OEM), or some other entity in some cases.

The resulting cost may be expressed as: 1) f_{cost}: projected cost of operation at end of billing period; and 2) Thresh_{cost}: maximum cost allowed to femtocell user. If a femtocell user is also a member of the femtocell, this threshold could be a function of the owner's own usage of the femtocell.

In some implementations, the cell-level information monitored at block 202 relates to data (e.g., bandwidth) throttling. If an ISP uses bandwidth throttling, a measure of how the femtocell user could be affected may be tracked (e.g., by keeping track of how close the user is to some known or assumed bandwidth limit such as 5 GB/month and/or by keeping track of the rate at which the user is approaching the limit).

The resulting throttling information may be expressed as: 1) fₜₕᵣₒₜₜₗₑ: likelihood that the cell owner will experience throttling; and 2) Thresh_{throttle,UEcat}: acceptable likelihood that admitting a UE of a given category (UE_{cat}) will trigger bandwidth throttling (e.g., UEcat can refer to a member/non-member, a particular priority level, etc.).

As represented by block 204, the femtocell monitors UE-level information that the femtocell will use to determine how to handle access terminals. Various quantities may be monitored by an access point at the UE level to acquire this information. The quantities may be instantaneous quantities, averages over a period of time, and so on. The quantities also may be expressed as a percentage of a quantity attributable to a given UE (e.g., one UE uses X % of a resource).

Example of these quantities include: f_{RoT}: Contribution of a given UE to the rise-over-thermal (RoT) measured at the femtocell; f_{CE}: Consumption of channel elements by a given UE; f_{DLTx}: Consumption of downlink transmit power associated with a given UE; f_{RAM}: Consumption of femtocell memory resources (e.g., amount and types of memory resources) associated with a given UE; f_{DL-Q}: Size of the downlink queue for a given UE; f_{TP-U}: Uplink throughput (T-put) for given UE; f_{TP-D}: Downlink throughput for a given UE; f_{TP-U,min}: Minimum uplink throughput for a given UE; f_{TP-D,min}: Minimum downlink throughput for a given UE; and Delay (e.g., RTT) for a given UE. It should be appreciated that the above quantities may be maintained for one or more sets of UEs (e.g., members versus non-members).

As represented by block 206, some or all of the information monitored at block 202 and/or block 204 may be shared among neighboring cells. For example, a cell may use the bandwidth information for neighboring cells to make hand-over decisions. In some embodiments, sharing may be achieved via broadcast (e.g., on BCCH) or via exchange of information between cells (e.g., via inter-cell over-the-air (OTA) exchange mechanisms or wired network interfaces). Examples of inter-cell OTA exchange mechanisms include: Cell Update mechanism (where information is transferred via customized U-RNTIs) and OTA out-of-band (OOB) (e.g., WiFi, Bluetooth, or some other wireless communication technology). OOB wireless interfaces can, as a non-exhaustive example, use standardized protocols (e.g., RNSAP, RANAP over corresponding stacks). Examples of network interfaces include Iur(h) and Iu(h). In some embodiments, sharing may be achieved by provisioning information to a centralized node in the network that is accessible by other nodes (e.g., Home NodeB Management System, Home NodeB Gateway, etc). In some embodiments, sharing may be achieved by configuring nodes with the information.

As represented by block 208, the femtocell determines (e.g., identifies) the category or categories assigned to its UEs (or any UEs requesting admission). Several examples of UE categories follow. It should be appreciated that other types of categories may be used in accordance with the teachings herein.

Member UEs may be differentiated from non-members as follows: 1) Member UEs may require access to local services (e.g., local IP access (LIPA)); 2) Member UEs may expect a minimal level of service (e.g., expressed in terms of OTA bandwidth and/or in terms of end-to-end bandwidth); and 3) Calls on licensed band may be priced at lower rate for member UEs in those cases where the call is on the femtocell (or the call is started on the femtocell).

The following priorities (from highest to lowest) may be employed in some embodiments: 1) UEs with emergency radio access bearers (RABs) regardless of membership; 2) Member UEs that do access local services (e.g., local printer, files), when remote IP access (RIPA) is not available; 3) Member UEs that can access local services (cell-level definition); 4) Other member UEs; and 5) Non-member UEs.

As represented by blocks 210 and 212, the femtocell determines the service priority for the UEs and, based on this prioritization and the monitored information, the femtocell determines how to handle its UEs. In some aspects, the determination of the UE service priority is based on whether the UE(s) currently being served by the femtocell is/are experiencing or would experience (e.g., due to admission of another UE) backhaul or OTA limits. In some aspects, the handling of a UE involves: determining how to perform a mobility operation, selecting a backhaul, or determining whether to adjust data allocation.

An example of a generalized framework for evaluating service priority follows. In general, member UEs may be given the best bandwidth on an equal grade of service (EGoS) basis when they access the same type of service (e.g., voice calls, web browsing). In addition, the admission of non-member UEs preferably will not affect the femtocell owner's cost of service. Also, the admission of non-member UEs preferably will not trigger bandwidth throttling for the femtocell owner.

One criterion for evaluating service priority involves determining whether UEs are limited by the femtocell's backhaul bandwidth. An example of a three-step process for making such a determination follows.

Step 1. If BW_{UL} and BW_{DL} are defined, compare the sum of the throughputs for all users with a defined percentage of the available bandwidth: Σ f_{TP-U}>(x %)*BW_{UL} and Σ f_{TP-D}>(x %)*BW_{DL}.

Step 2. If either of BW_{UL} and BW_{DL} is undefined and OTA is not bandwidth-limited for any member UE: assume no limitation occurs in that direction (UL or DL).

Step 3. If a bandwidth limitation is observed, manage (e.g., throttle or hand-out to other cell or RAT) the non-members UEs: 1) Until no further bandwidth increase occurs for member UEs; and/or 2) Until acceptable bandwidth or RTT is observed for member UEs. For example, this latter condition may involve comparing the bandwidth achieved by a member UE with the minimum acceptable bandwidth for member UEs: e.g., f_{TP-D,UE}>f_{TP-D,min,member}.

Another criterion for evaluating service priority involves determining whether UEs are limited by the OTA bandwidth. If the UEs are limited on the downlink (DL), the UE's DL queue may be set to be greater than a threshold limit (e.g., DLq_thresh). If the UEs are limited on the uplink (UL), further allocation of UL resources may not result in increase of UE UL throughput. However, UL resources may be made available by handing-out lower priority UEs, if the femtocell's own allocation cannot be increased. Alternatively, OTA bandwidth limitation for specific UEs may be observed from requests by UEs for additional OTA resources (e.g., Happy Bit in HSUPA).

An example of a test that may be employed to determine whether to admit a UE to a cell or keep a UE in a cell follows. In some aspects, this test may be employed to determine whether resources would be negatively impacted to an unacceptable degree if the UE was admitted or if the UE remains in the cell.

UE gets admitted to cell if all of the following are met: 1) f_{cost}<Thresh_{cost}, as expected after admission of user; and 2) fₜₕᵣₒₜₜₗₑ<Thresh_{throttle,UEcat}, as expected after admission of user; and 3) f_{RoT/CE/DLTx/RAM}<Thresh_{RoT/CE/DLTx/RAM} (for any of these parameters being considered) as expected after admission of a user, including the option that a lower-priority user will be down-scaled or handed-out, to free up resources for the new user; and 4a) backhaul or OTA bandwidth limitation is not observed in cell (in cases where all users are of the same priority or higher), or 4b) if some cell users are of lower priority; and 5) UE has not undergone ping-ponging.

The above criteria may also be evaluated on a periodic basis to determine whether the current UE service set remains admissible. Different thresholds may be used in this “keep UE” evaluation; and evaluation may be started from the lowest priority UE.

An example of a test that may be employed to determine whether to hand-out a UE to another cell or keep a UE in a cell follows. A UE is a candidate for hand-out for service reasons if: 1) It is determined that current UE service it not admissible anymore; 2) No lower-priority users exists in the cell; or 3) This UE is determined to consume the most resources.

As mentioned above, an access point may identify a particular access point or cell to which an access terminal is to be handed-off. Examples of criteria that may be employed to identify the target access point or cell follow.

UE may be handed-out to a cell, for service reasons if: 1) the UE is a candidate for handout for service reasons; 2) the cell can admit the UE for service reasons; and 3) the UE's measurements of the considered target cell are good enough. Examples of the latter test include: CPICH RSCP>thresh_{RSCP}, CPICH Ec/Io>thresh_{Ec/Io}, or the cell fulfils other criteria (e.g., suitable offload target).

If multiple target cells exist for service, for mobility purposes, the following UE criteria may be considered to select one target: 1) UE priority (e.g., the user prefers to use certain cells); and 2) cost to UE and/or target femtocell owner to have UE use the target cell(s).

Several additional examples of actions that may be taken if resources usage is too high follow:

1. Hand-out of chosen UEs from overloaded cells.

2. Adjust coverage of cell (e.g., by adjusting transmit power and/or frequency). For example, while maintaining system coverage (e.g., RSSI monitored by network listen module), increase coverage of underloaded cells or decrease coverage of overloaded cells. Adjustments can be done based on event triggers (e.g., if bandwidth falls below a threshold), or periodically (e.g., determine f_{cost} every night and take action based on that determination).

3. Adjust connected mode hand-out parameters (e.g., CELL_DCH in UMTS or RRC_Connected in LTE): to ensure offload of more or of fewer UEs. These adjustments may be made within the boundaries needed to ensure good radio frequency (RF) performance (e.g., hand-out later if cell is underloaded, and hand-out earlier if cell is overloaded).

4. Adjust reselection parameters. For example, increase cell individual offset (CIO) of underloaded cells.

5. Throttle grant and/or TFCI allocations, for example, if no handout candidate cell is found. This may result, for example, in a change in allocated data rates.

6. Move UE from CELL_DCH to CELL_FACH, for example, if no handout candidate cell is found. This may, for example, reduce the number of channel elements being used.

7. Adjust thresholds for soft handover (SHO) and/or for simultaneous preparation of hand-in channels. For example, allow fewer UEs to use SHO if the channel elements are overloaded. Examples of adjusting SHO thresholds include adjusting an event 1a reporting range, adjusting a hysteresis, and adjusting a cell CIO.

8. Notify operator when overload cannot be tackled. For example, operator can choose to deploy additional cells, or upgrade a user's equipment.

9. Offload users to another technology (e.g., 3GPP2 technology, IEEE 802.11-based technology, etc.).

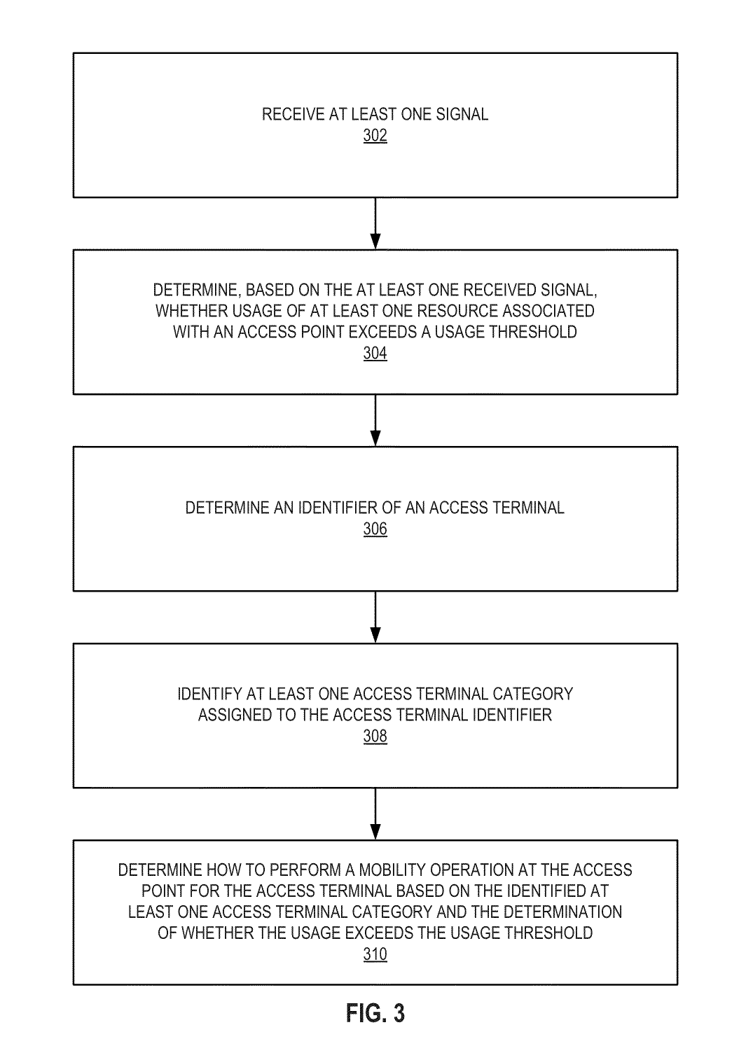

With the above in mind, additional operations relating to communication management according to the teachings herein will be described in conjunction with the flowcharts of FIGS. 3-9. For purposes of illustration, these operations are described in the context of a system where an access point (e.g., a femtocell) serves one or more access terminals (e.g., UEs). It should be appreciated, however, that the concepts that follow are applicable to other scenarios and devices. For example, some of these operations may be performed by a network entity.

FIG. 3 illustrates sample operations for determining how to perform a mobility operation based on resource usage and access terminal category information. For example, if usage of a particular resource exceeds a usage threshold, the mobility operations of the access point may be affected in a manner that attempts to ensure that the resources of the access point are biased towards use by higher priority access terminals.

As represented by block 302, the access point receives at least one signal. For example, the access point may monitor received signals in conjunction with the monitoring operations described above at blocks 202 and 204. As another example, the access point may receive signals from other access points in conjunction with information sharing operations described above at block 206. For example, the access point may receive information indicative of resource usage from another entity in the network (e.g., another access point or a network entity). As another example, the access point may monitor its uplink and/or downlink traffic flows to determine resource usage.

As represented by block 304, the access point determines, based on the signal(s) received at block 302, whether usage of at least one resource associated with the access point exceeds a usage threshold. Examples of these resources include: backhaul bandwidth used, backhaul capacity, channel element, resource cost, data throttling limit, over-the-air bandwidth used, over-the-air capacity, transmit power, memory resource, downlink load, and uplink load. Generally, each type of resource will be compared with a corresponding type of usage threshold.

In some cases, a portion of one or more of the resources associated with an access point is reserved for the access terminal based on the least one access terminal category associated with the access terminal. For example, as discussed herein, certain resources may be reserved for high priority member access terminals. Consequently, the resources considered at block 304 may depend on the access terminal(s) currently being served and/or potentially being served (e.g., an access terminal requesting admission) by the access point. For example, the access point may not evaluate usage of a reserved resource when determining whether to admit a non-member or low-priority access terminal.

As represented by block 306, the access point determines an identifier of an access terminal. For example, the access point may acquire this information from the access terminal when the access terminal requests access (e.g., admittance) to the access point.

As represented by block 308, the access point identifies at least one category assigned to the access terminal identifier. Such an access terminal category may be indicative of one or more of, for example: access terminal priority, access terminal ownership, access terminal group membership, access terminal class type, access terminal payment plan, or access terminal provisioning. As an example of access terminal class type, some types of access terminals (e.g., cell phones carrying high QoS traffic) may be given more preference than other types of access terminals (e.g., sensors that have non-urgent data to report). As discussed herein, different access terminals may be associated with different categories at a given access point.

As represented by block 310, the access point determines how to perform a mobility operation at the access point for the access terminal. This determination is based, at least in part, on the at least one access terminal category identified at block 308 and the determination of block 304 as to whether the usage exceeds the usage threshold. In some aspects, the usage threshold(s) may depend on the access terminal category (identified at block 308).

In some implementations, the determination of how to perform the mobility operation comprises determining whether to hand-over the access terminal to a second access point. For example, the access terminal may elect to hand-out certain access terminals if the access point is currently unable to provide adequate QoS for its high priority access terminals.

In this case, the access point may select the second access point based on various criteria. For example, the access point may identify the second access point for the handover based on at least one available resource of the second access point (e.g., based on whether the second access point has more available resources than other potential target access points and/or the source access point). As another example, the access point may identify the second access point for the handover based on an access point priority specified for the access terminal (e.g., there may be a preference to hand the access terminal over to certain access points). As yet another example, the access point may identify the second access point for the handover based on a cost associated with the access terminal accessing the second access point (e.g., service may be less expensive at some access points).

In some implementations, the access point hands the access terminal over to a different communication technology (e.g., Wi-Fi, etc.). For example, the access terminal may be served by a source access point via a first wireless communication technology, and the target access point may provide service for the handover via a second wireless communication technology.

In some implementations, the determination of how to perform the mobility operation comprises determining whether to adjust a mobility parameter at the access point for the access terminal. For example, if the QoS the access point can provide to its high priority access terminals is unacceptable, the access point may adjust one or more mobility parameters in an attempt to cause: fewer access terminals to reselect to the access point, fewer access terminals to be handed-in to the access point, or more access terminals to be handed-out from the access point. Such mobility parameters may comprise, for example, handover parameters, connected mode handout parameters, reselection parameters, or soft handover parameters.

In some implementations, the determination of how to perform the mobility operation comprises determining whether to admit the access terminal for service from the access point. For example, the access terminal may not be admitted if admission would adversely affect the QoS the access point can provide to its high priority access terminals.

In some cases, as a result of the determination of whether to admit the access terminal, the access point may determine whether to hand-over another access terminal currently being served by the access point to another access point. For example, the access point may admit a high priority access terminal only after handing-off a lower priority access terminal (e.g., to maintain an adequate level of resources for high priority access terminals).

In some cases, the determination of whether to admit the access terminal is based on a quantity of times that the access terminal has been admitted to and handed-over from the access point over a defined period of time. For example, an access point may elect to not admit an access terminal if has been the subject of recent ping-ponging (e.g., admission, handout, admission, handout, and so on over a relatively short period of time).

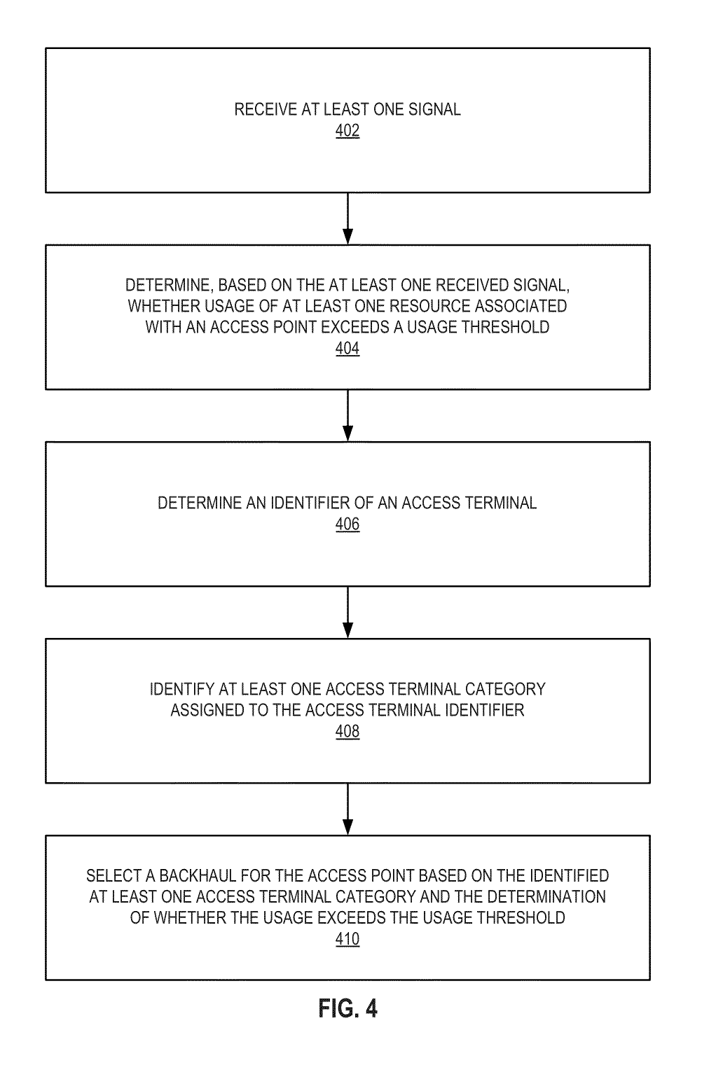

FIG. 4 illustrates sample operations for selecting a backhaul based on resource usage and access terminal category information. For example, if usage of a particular resource (e.g., the current backhaul) exceeds a usage threshold, the access point may use a different backhaul (e.g., of a neighbor access point) to service the access point's access terminals (e.g., the higher priority access terminals). The operations of blocks 402-408 may be similar to the operations of blocks 302-308. Hence, these operations will not be described here.

As represented by block 410, the access point selects a backhaul to be used for serving one or more of its access terminals. This selection is based on the at least one access terminal category identified at block 408 and the determination at block 404 as to whether the usage exceeds the usage threshold. For example, if the access point's backhaul is overloaded and a neighbor access point's backhaul is not, the access point may select a different backhaul (the neighbor's backhaul) to service a newly admitted high priority access terminal.

The selection of the backhaul may be accomplished in various ways. In some aspects, the selection of the backhaul may comprise switching from a first backhaul associated with the access point to a second backhaul associated with a second access point. In this case, at least one wireless communication link may be established between the access point and the second access point to transfer information between the access terminal and the second backhaul. In some aspects, the selection of the backhaul may comprise selecting a user plane attach point. For example, the access point may switch from a first user plane attach point associated with the access point to a second user plane attach point associated with a second access point.

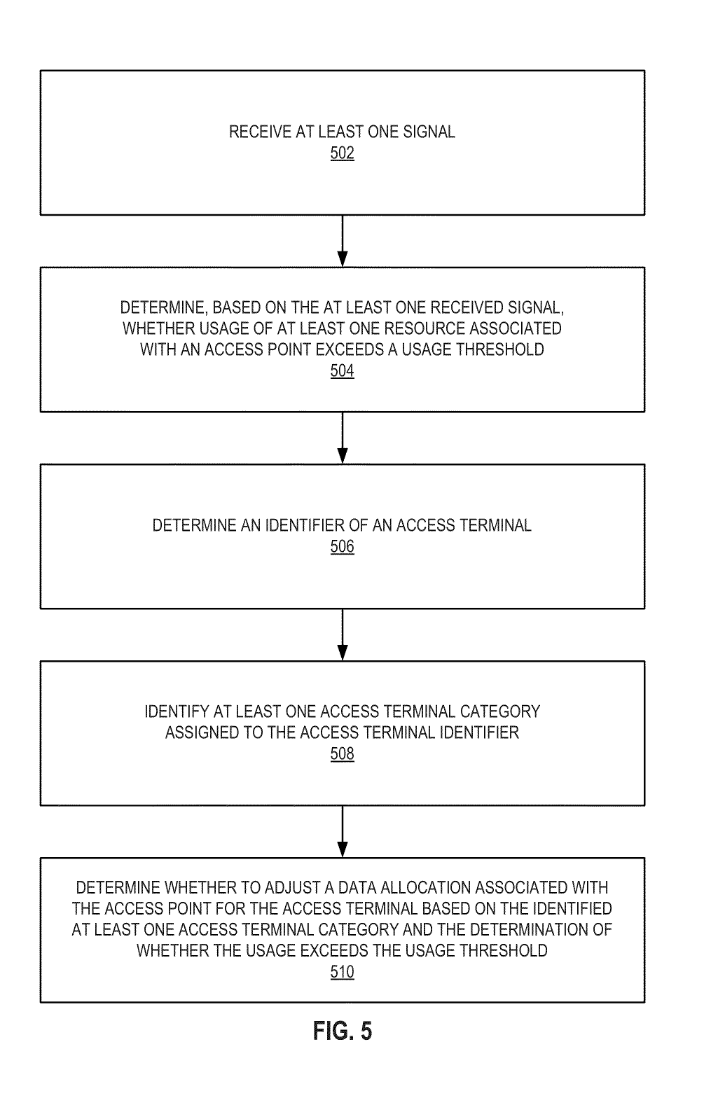

FIG. 5 illustrates sample operations for determining whether to adjust data allocation based on resource usage and access terminal category information. For example, if usage of a particular resource exceeds a usage threshold, the access point may reduce the data allocation for lower priority access terminals in an attempt to ensure that higher priority access terminals are provided with adequate QoS. The operations of blocks 502-508 may be similar to the operations of blocks 302-308. Hence, these operations will not be described here.

As represented by block 510, the access point determines whether to adjust a data allocation associated with the access point for the access terminal. For example, the adjustment of the data allocation may involve adjusting traffic load on a downlink to the access terminal and/or adjusting traffic load on an uplink from the access terminal.

The determination of block 510 is based on the at least one access terminal category identified at block 508 and the determination at block 504 as to whether the usage exceeds the usage threshold. For example, the data allocation for a low priority access terminal may be reduced if the high priority access terminals are being subjected to a resource limitation.

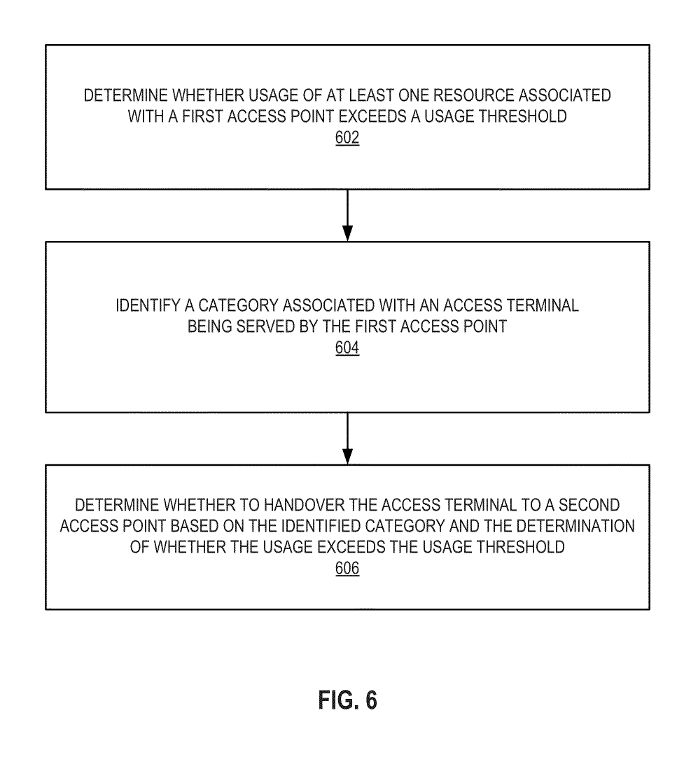

FIG. 6 illustrates sample operations for determining whether to hand-over an access terminal based on resource usage and an access terminal category. For example, if usage of a particular resource exceeds a usage threshold, a lower priority access terminal may be handed-over from a first access point to a second access point. In this way, the resources of the first access point may be preserved for higher priority access terminals.

As represented by block 602, a determination is made as to whether at least one resource associated with a first access point exceeds a usage threshold. The resource (or resources) may correspond, for example, to the resources described above at FIG. 3. Again, each type of resource will be compared with a corresponding type of usage threshold.

In some aspects, the first access point may determine the usage of a given resource based on information received by the first access point and/or based on information transmitted by the first access point. For example, the first access point may receive information indicative of resource usage from another entity in the network (e.g., another access point or a network entity). As another example, the first access point may monitor its uplink and/or downlink traffic flows to determine resource usage.

As represented by block 604, a category associated with an access terminal being served by the first access point is identified. The category (or categories) may correspond, for example, to the access terminal categories described above at FIG. 3. Again, different access terminals may be associated with different categories at a given access point.

As represented by block 606, a determination is made as to whether to hand-over the access terminal to a second access point. This determination is based, at least in part, on the identified category and the determination of whether the usage exceeds the usage threshold. Usage thresholds may depend on the access terminal category, as determined by block 604.

In conjunction with determining whether to hand-over the access terminal, the target access point for the handover (the second access point in this case) is identified. In some cases, this involves identifying one access point from a set of prospective target access points. In some aspects, the identification of the target access point is based on at least one available resource of the second access point (e.g., whether the second access point has more resources available for the access terminal than the first access point). In some aspects, the identification of the target access point is based on an access point priority specified for the access terminal (e.g., whether the access terminal prefers to receive service from a given access point) and/or based on a cost associated with the access terminal accessing the second access point (e.g., whether and/or how much the access terminal user must pay to use a given access point).

If a decision is made to hand-over the access terminal, the first access point sends a message (e.g., to the network or to the second access point) to initiate the handover.

The access terminal may be handed-over to an access point that uses the same wireless communication technology as the first access point or to an access point that uses different wireless communication technology. For example, an access point serving an access terminal via cellular technology may hand the access terminal over to an access point that will provide service via Wi-Fi technology.

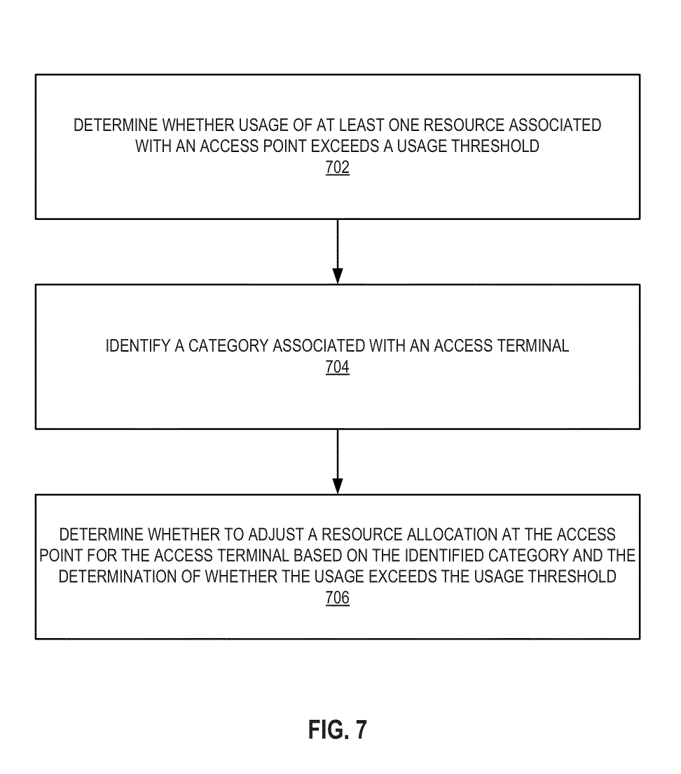

FIG. 7 illustrates sample operations for determining whether to adjust a resource allocation based on resource usage and an access terminal category. The operations of blocks 702 and 704 may be similar to the operations of blocks 602 and 604. Hence, these operations will not be described here.

As represented by block 706, a determination is made as to whether to adjust a resource allocation at the access point for the access terminal based on the identified category and the determination of whether the usage exceeds the usage threshold for the access point and particular access terminal category. For example, if usage of a particular resource exceeds a usage threshold, a resource allocation for a lower priority access terminal may be reduced. In this way, the resources of the first access point may be preserved for higher priority access terminals. In some aspects, the adjustment of the resource allocation comprises adjusting a data allocation (e.g., transmit format combination indicator (TFCI) allocation) for the access terminal. In some aspects, the adjustment of the resource allocation comprises adjusting a radio state (e.g., from CELL_DCH to CELL_FACH, etc.) for the access terminal. In some aspects, the adjustment of the resource allocation comprises rewriting a resource allocation parameter value stored in a memory component (e.g., a memory device).

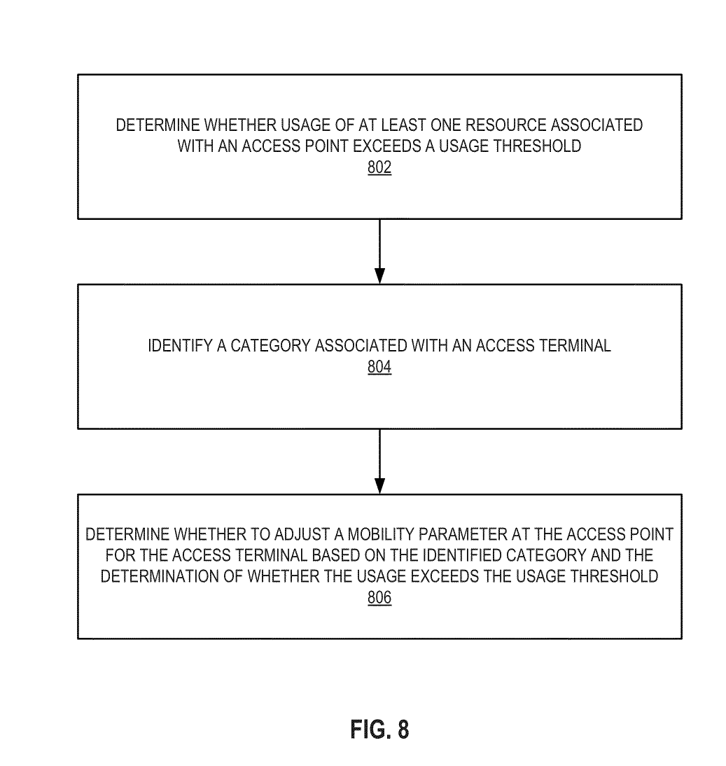

FIG. 8 illustrates sample operations for determining whether to adjust a mobility parameter based on resource usage and an access terminal category. The operations of blocks 802 and 804 may be similar to the operations of blocks 602 and 604. Hence, these operations will not be described here.

As represented by block 806, a determination is made as to whether to adjust a mobility parameter at the access point for the access terminal based on the identified category and the determination of whether the usage exceeds the usage threshold for the access point and particular access terminal category. For example, if usage of a particular resource exceeds a usage threshold, a mobility parameter for a lower priority access terminal may be adjusted to increase the likelihood of handover of that access terminal to another access point. In this way, the resources of the first access point may be preserved for higher priority access terminals. In some aspects, the adjustment of the mobility parameter comprises adjusting a handover parameter (e.g., a CELL_DCH hand-out parameter). In some aspects, the adjustment of the mobility parameter comprises adjusting a reselection parameter. In some aspects, the adjustment of the mobility parameter comprises adjusting a soft handover threshold (e.g., adjusting an event 1a reporting range, adjusting a hysteresis, adjusting a cell CIO, or adjusting some combination of these parameters). In some aspects, the adjustment of the mobility parameter comprises rewriting a mobility parameter value stored in a memory component.

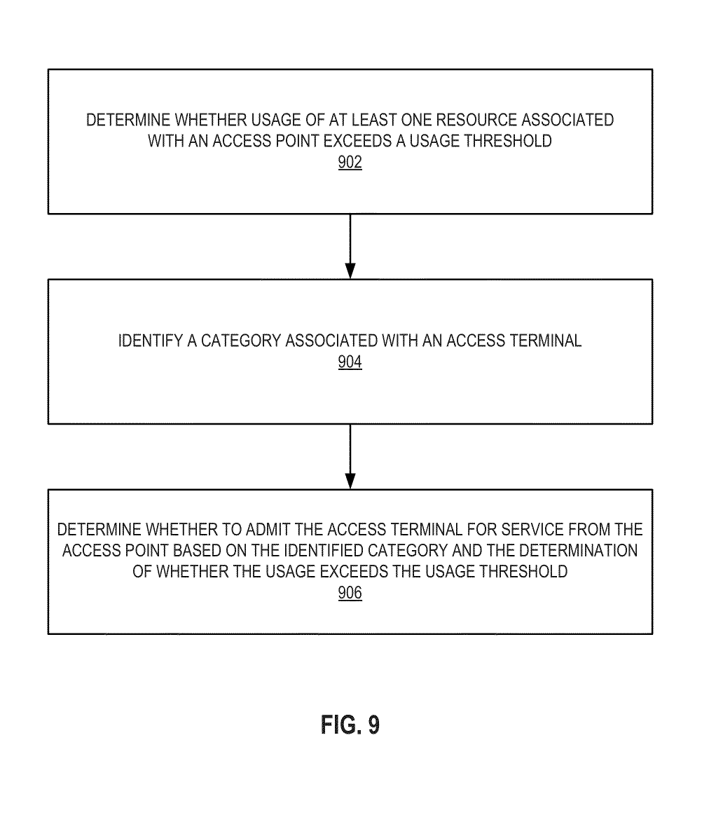

FIG. 9 illustrates sample operations for determining whether to admit an access terminal based on resource usage and an access terminal category. The operations of blocks 902 and 904 may be similar to the operations of blocks 602 and 604. Hence, these operations will not be described here.

As represented by block 906, a determination is made as to whether to admit the access terminal for service from the access point based on the identified category and the determination of whether the usage exceeds the usage threshold for the access point and particular access terminal category. For example, if usage of a particular resource exceeds a usage threshold, a lower priority access terminal may be denied admission so that resources of the first access point may be preserved for higher priority access terminals. In some aspects, the determination of whether to admit the access terminal is further based on the number of times that the access terminal has been admitted to and handed-over from the access point over a defined period of time (e.g., an access terminal that has recently been “ping-ponging” between admission and handover may be denied admission).

If a decision is made to admit the access terminal, the access point sends a message (e.g., to the network or to another access point) to initiate the admission of the access terminal. In addition, if the access terminal is admitted, the access point may determine whether to hand-over another access terminal currently being served by the access point to another access point. For example, the access point may hand-over a lower priority access terminal if a higher priority access terminal has been granted admission.

FIG. 10 illustrates several sample components (represented by corresponding blocks) that may be incorporated into an apparatus 1002 or an apparatus 1004 (e.g., corresponding to the access point 106 or the network entity 110 of FIG. 1, respectively) to perform communication management-related operations as taught herein. It should be appreciated that these components may be implemented in different types of apparatuses in different implementations (e.g., in an ASIC, in a system on a chip (SoC), etc.). The described components also may be incorporated into other nodes in a communication system. For example, other nodes in a system may include components similar to those described for the apparatuses 1002 and 1004 to provide similar functionality. Also, a given node may contain one or more of the described components. For example, an apparatus may include multiple transceiver components that enable the apparatus to operate on multiple carriers and/or communicate via different technologies.

The apparatus 1002 includes at least one communication component 1006 (e.g., at least one wireless transceiver device) for communicating with other nodes via at least one designated radio access technology. The communication component 1006 includes at least one transmitter 1012 for transmitting signals (e.g., messages, indications, information, and so on) and at least one receiver 1014 for receiving signals (e.g., messages, indications, information, and so on). In some embodiments, a communication component (e.g., one of multiple wireless communication devices) of the apparatus 1002 comprises a network listen module.

The apparatus 1002 and the apparatus 1004 each include one or more communication components 1008 and 1010 (e.g., one or more network interface devices), respectively, for communicating with other nodes (e.g., other network entities). For example, each of the communication components 1008 and 1010 may be configured to communicate with one or more network entities via a wire-based or wireless backhaul or backbone. In some aspects, each of the communication components 1008 and 1010 may be implemented as a transceiver configured to support wire-based or wireless communication. This communication may involve, for example, sending and receiving: messages, parameters, other types of information, and so on. Accordingly, in the example of FIG. 10, the communication component 1008 is shown as comprising a transmitter 1016 for sending signals and a receiver 1018 for receiving signals. Similarly, the communication component 1010 is shown as comprising a transmitter 1020 for sending signals and a receiver 1022 for receiving signals.

The apparatuses 1002 and 1004 also include other components that may be used in conjunction with communication management-related operations as taught herein. For example, the apparatus 1002 includes a processing system 1024 for providing functionality relating to managing communication in accordance with the teachings herein (e.g., mobility management-related operations, data allocation-related operations, backhaul selection-related operations, handover-related operations, resource allocation-related operations, admission-related operations) and for providing other processing functionality. Similarly, the apparatus 1004 includes a processing system 1026 for providing functionality relating to managing communication in accordance with the teachings herein (e.g., as discussed above) and for providing other processing functionality. Each of the apparatuses 1002 or 1004 includes a respective memory component 1028 or 1030 (e.g., each including a memory device) for maintaining information (e.g., information, thresholds, parameters, and so on). In addition, each apparatus 1002 or 1004 includes a user interface device 1032 or 1034 for providing indications (e.g., audible and/or visual indications) to a user and/or for receiving user input (e.g., upon user actuation of a sensing device such a keypad, a touch screen, a microphone, and so on).

For convenience, the apparatuses 1002 and 1004 are shown in FIG. 10 as including components that may be used in the various examples described herein. In practice, the illustrated blocks may have different functionality in different implementations. For example, the functionality of the block 1024 or 1026 may be different when supporting the scheme of FIG. 4 as compared to the functionality of the block 1024 or 1026 when supporting the scheme of FIG. 5.

The components of FIG. 10 may be implemented in various ways. In some implementations, the components of FIG. 10 may be implemented in one or more circuits such as, for example, one or more processors and/or one or more ASICs (which may include one or more processors). Here, each circuit may use and/or incorporate at least one memory component for storing information or executable code used by the circuit to provide this functionality. For example, some or all of the functionality represented by blocks 1006, 1008, 1024, 1028, and 1032 may be implemented by processor and memory component(s) of the apparatus 1002 (e.g., by execution of appropriate code and/or by appropriate configuration of processor components). Similarly, some or all of the functionality represented by blocks 1010, 1026, 1030, and 1034 may be implemented by processor and memory component(s) of the apparatus 1004 (e.g., by execution of appropriate code and/or by appropriate configuration of processor components).

As discussed above, in some aspects the teachings herein may be employed in a network that includes macro scale coverage (e.g., a large area cellular network such as a 3G network, typically referred to as a macro cell network or a WAN) and smaller scale coverage (e.g., a residence-based or building-based network environment, typically referred to as a LAN). As an access terminal (AT) moves through such a network, the access terminal may be served in certain locations by access points that provide macro coverage while the access terminal may be served at other locations by access points that provide smaller scale coverage. In some aspects, the smaller coverage nodes may be used to provide incremental capacity growth, in-building coverage, and different services (e.g., for a more robust user experience).

In the description herein, a node (e.g., an access point) that provides coverage over a relatively large area may be referred to as a macro access point while a node that provides coverage over a relatively small area (e.g., a residence) may be referred to as a femto access point. It should be appreciated that the teachings herein may be applicable to nodes associated with other types of coverage areas. For example, a pico access point may provide coverage (e.g., coverage within a commercial building) over an area that is smaller than a macro area and larger than a femto area. In various applications, other terminology may be used to reference a macro access point, a femto access point, or other access point-type nodes. For example, a macro access point may be configured or referred to as an access node, base station, access point, eNodeB, macro cell, and so on. Also, a femto access point may be configured or referred to as a Home NodeB, Home eNodeB, access point base station, femto cell, and so on. In some implementations, a node may be associated with (e.g., referred to as or divided into) one or more cells or sectors. A cell or sector associated with a macro access point, a femto access point, or a pico access point may be referred to as a macro cell, a femto cell, or a pico cell, respectively.

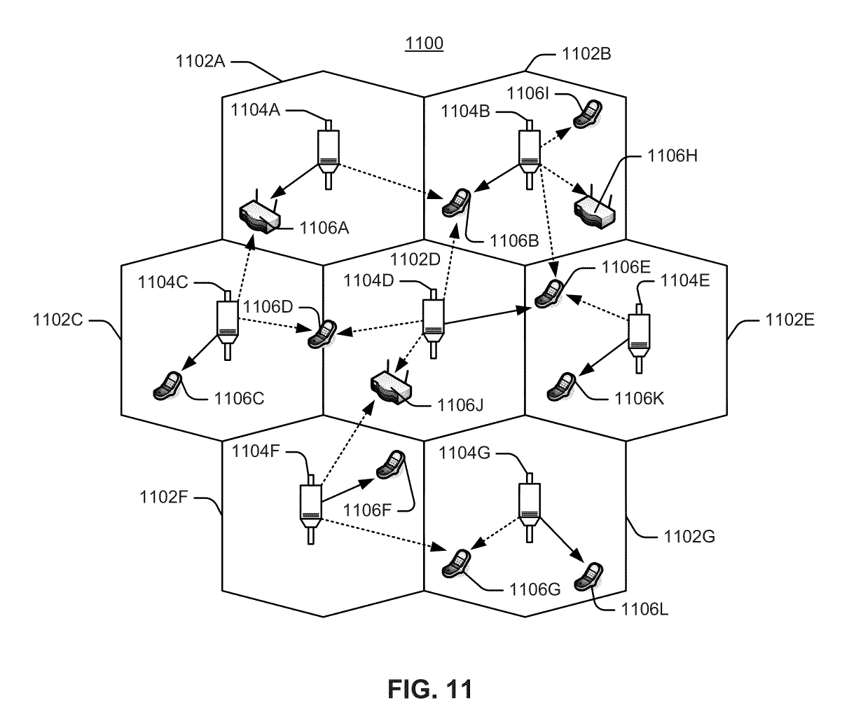

FIG. 11 illustrates a wireless communication system 1100, configured to support a number of users, in which the teachings herein may be implemented. The system 1100 provides communication for multiple cells 1102, such as, for example, macro cells 1102A-1102G, with each cell being serviced by a corresponding access point 1104 (e.g., access points 1104A-1104G). As shown in FIG. 11, access terminals 1106 (e.g., access terminals 1106A-1106L) may be dispersed at various locations throughout the system over time. Each access terminal 1106 may communicate with one or more access points 1104 on a forward link (FL) and/or a reverse link (RL) at a given moment, depending upon whether the access terminal 1106 is active and whether it is in soft handover, for example. The wireless communication system 1100 may provide service over a large geographic region. For example, macro cells 1102A-1102G may cover a few blocks in a neighborhood or several miles in a rural environment.

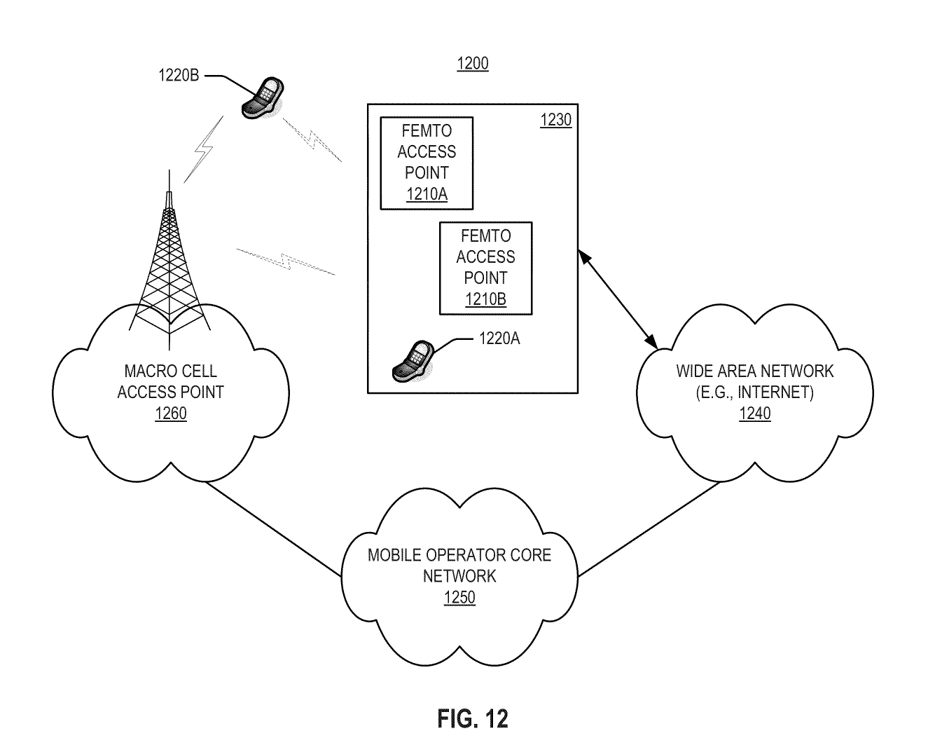

FIG. 12 illustrates an exemplary communication system 1200 where one or more femto access points are deployed within a network environment. Specifically, the system 1200 includes multiple femto access points 1210 (e.g., femto access points 1210A and 1210B) installed in a relatively small scale network environment (e.g., in one or more user residences 1230). Each femto access point 1210 may be coupled to a wide area network 1240 (e.g., the Internet) and a mobile operator core network 1250 via a DSL router, a cable modem, a wireless link, or other connectivity means (not shown). As will be discussed below, each femto access point 1210 may be configured to serve associated access terminals 1220 (e.g., access terminal 1220A) and, optionally, other (e.g., hybrid or alien) access terminals 1220 (e.g., access terminal 1220B). In other words, access to femto access points 1210 may be restricted whereby a given access terminal 1220 may be served by a set of designated (e.g., home) femto access point(s) 1210 but may not be served by any non-designated femto access points 1210 (e.g., a neighbor's femto access point 1210).

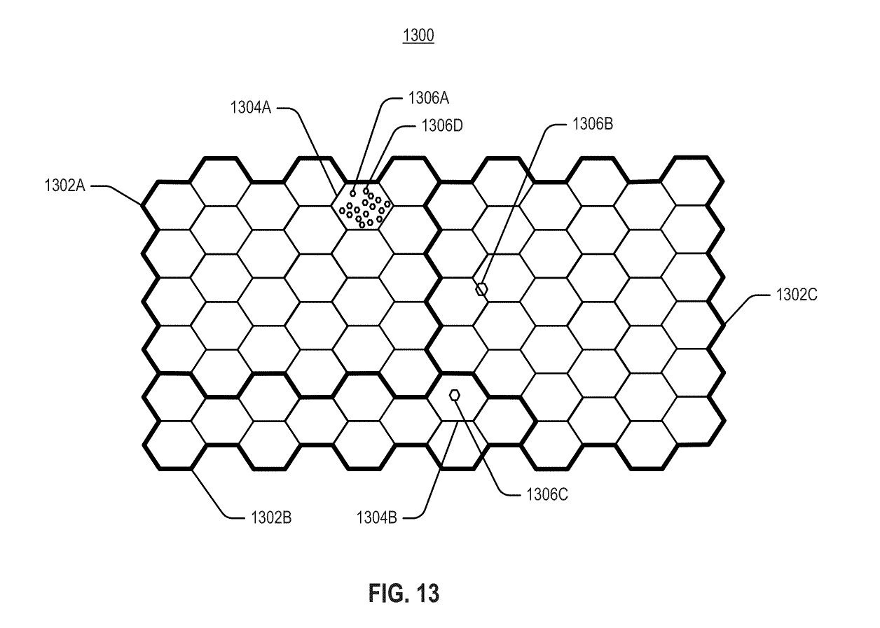

FIG. 13 illustrates an example of a coverage map 1300 where several tracking areas 1302 (or routing areas or location areas) are defined, each of which includes several macro coverage areas 1304. Here, areas of coverage associated with tracking areas 1302A, 1302B, and 1302C are delineated by the wide lines and the macro coverage areas 1304 are represented by the larger hexagons. The tracking areas 1302 also include femto coverage areas 1306. In this example, each of the femto coverage areas 1306 (e.g., femto coverage areas 1306B and 1306C) is depicted within one or more macro coverage areas 1304 (e.g., macro coverage areas 1304A and 1304B). It should be appreciated, however, that some or all of a femto coverage area 1306 might not lie within a macro coverage area 1304. In practice, a large number of femto coverage areas 1306 (e.g., femto coverage areas 1306A and 1306D) may be defined within a given tracking area 1302 or macro coverage area 1304. Also, one or more pico coverage areas (not shown) may be defined within a given tracking area 1302 or macro coverage area 1304.

Referring again to FIG. 12, the owner of a femto access point 1210 may subscribe to mobile service, such as, for example, 3G mobile service, offered through the mobile operator core network 1250. In addition, an access terminal 1220 may be capable of operating both in macro environments and in smaller scale (e.g., residential) network environments. In other words, depending on the current location of the access terminal 1220, the access terminal 1220 may be served by a macro cell access point 1260 associated with the mobile operator core network 1250 or by any one of a set of femto access points 1210 (e.g., the femto access points 1210A and 1210B that reside within a corresponding user residence 1230). For example, when a subscriber is outside his home, he is served by a standard macro access point (e.g., access point 1260) and when the subscriber is at home, he is served by a femto access point (e.g., access point 1210A). Here, a femto access point 1210 may be backward compatible with legacy access terminals 1220.

A femto access point 1210 may be deployed on a single frequency or, in the alternative, on multiple frequencies. Depending on the particular configuration, the single frequency or one or more of the multiple frequencies may overlap with one or more frequencies used by a macro access point (e.g., access point 1260).

In some aspects, an access terminal 1220 may be configured to connect to a preferred femto access point (e.g., the home femto access point of the access terminal 1220) whenever such connectivity is possible. For example, whenever the access terminal 1220A is within the user's residence 1230, it may be desired that the access terminal 1220A communicate only with the home femto access point 1210A or 1210B.

In some aspects, if the access terminal 1220 operates within the macro cellular network 1250 but is not residing on its most preferred network (e.g., as defined in a preferred roaming list), the access terminal 1220 may continue to search for the most preferred network (e.g., the preferred femto access point 1210) using a better system reselection (BSR) procedure, which may involve a periodic scanning of available systems to determine whether better systems are currently available and subsequently acquire such preferred systems. The access terminal 1220 may limit the search for specific band and channel. For example, one or more femto channels may be defined whereby all femto access points (or all restricted femto access points) in a region operate on the femto channel(s). The search for the most preferred system may be repeated periodically. Upon discovery of a preferred femto access point 1210, the access terminal 1220 selects the femto access point 1210 and registers on it for use when within its coverage area.

Access to a femto access point may be restricted in some aspects. For example, a given femto access point may only provide certain services to certain access terminals. In deployments with so-called restricted (or closed) access, a given access terminal may only be served by the macro cell mobile network and a defined set of femto access points (e.g., the femto access points 1210 that reside within the corresponding user residence 1230). In some implementations, an access point may be restricted to not provide, for at least one node (e.g., access terminal), at least one of: signaling, data access, registration, paging, or service.

In some aspects, a restricted femto access point (which may also be referred to as a Closed Subscriber Group Home NodeB) is one that provides service to a restricted provisioned set of access terminals. This set may be temporarily or permanently extended as necessary. In some aspects, a Closed Subscriber Group (CSG) may be defined as the set of access points (e.g., femto access points) that share a common access control list of access terminals.

Various relationships may thus exist between a given femto access point and a given access terminal. For example, from the perspective of an access terminal, an open femto access point may refer to a femto access point with unrestricted access (e.g., the femto access point allows access to any access terminal). A restricted femto access point may refer to a femto access point that is restricted in some manner (e.g., restricted for access and/or registration). A home femto access point may refer to a femto access point on which the access terminal is authorized to access and operate on (e.g., permanent access is provided for a defined set of one or more access terminals). A hybrid (or guest) femto access point may refer to a femto access point on which different access terminals are provided different levels of service (e.g., some access terminals may be allowed partial and/or temporary access while other access terminals may be allowed full access). An alien femto access point may refer to a femto access point on which the access terminal is not authorized to access or operate on, except for perhaps emergency situations (e.g., 911 calls).

From a restricted femto access point perspective, a home access terminal may refer to an access terminal that is authorized to access the restricted femto access point installed in the residence of that access terminal's owner (usually the home access terminal has permanent access to that femto access point). A guest access terminal may refer to an access terminal with temporary access to the restricted femto access point (e.g., limited based on deadline, time of use, bytes, connection count, or some other criterion or criteria). An alien access terminal may refer to an access terminal that does not have permission to access the restricted femto access point, except for perhaps emergency situations, for example, such as 911 calls (e.g., an access terminal that does not have the credentials or permission to register with the restricted femto access point).

For convenience, the disclosure herein describes various functionality in the context of a femto access point. It should be appreciated, however, that a pico access point may provide the same or similar functionality for a larger coverage area. For example, a pico access point may be restricted, a home pico access point may be defined for a given access terminal, and so on.

The teachings herein may be employed in a wireless multiple-access communication system that simultaneously supports communication for multiple wireless access terminals. Here, each terminal may communicate with one or more access points via transmissions on the forward and reverse links. The forward link (or downlink) refers to the communication link from the access points to the terminals, and the reverse link (or uplink) refers to the communication link from the terminals to the access points. This communication link may be established via a single-in-single-out system, a multiple-in-multiple-out (MIMO) system, or some other type of system.

A MIMO system employs multiple (N_{T}) transmit antennas and multiple (N_{R}) receive antennas for data transmission. A MIMO channel formed by the N_{T} transmit and N_{R} receive antennas may be decomposed into N_{S} independent channels, which are also referred to as spatial channels, where N_{S}≦min{N_{T}, N_{R}}. Each of the N_{S} independent channels corresponds to a dimension. The MIMO system may provide improved performance (e.g., higher throughput and/or greater reliability) if the additional dimensionalities created by the multiple transmit and receive antennas are utilized.

A MIMO system may support time division duplex (TDD) and frequency division duplex (FDD). In a TDD system, the forward and reverse link transmissions are on the same frequency region so that the reciprocity principle allows the estimation of the forward link channel from the reverse link channel. This enables the access point to extract transmit beam-forming gain on the forward link when multiple antennas are available at the access point.

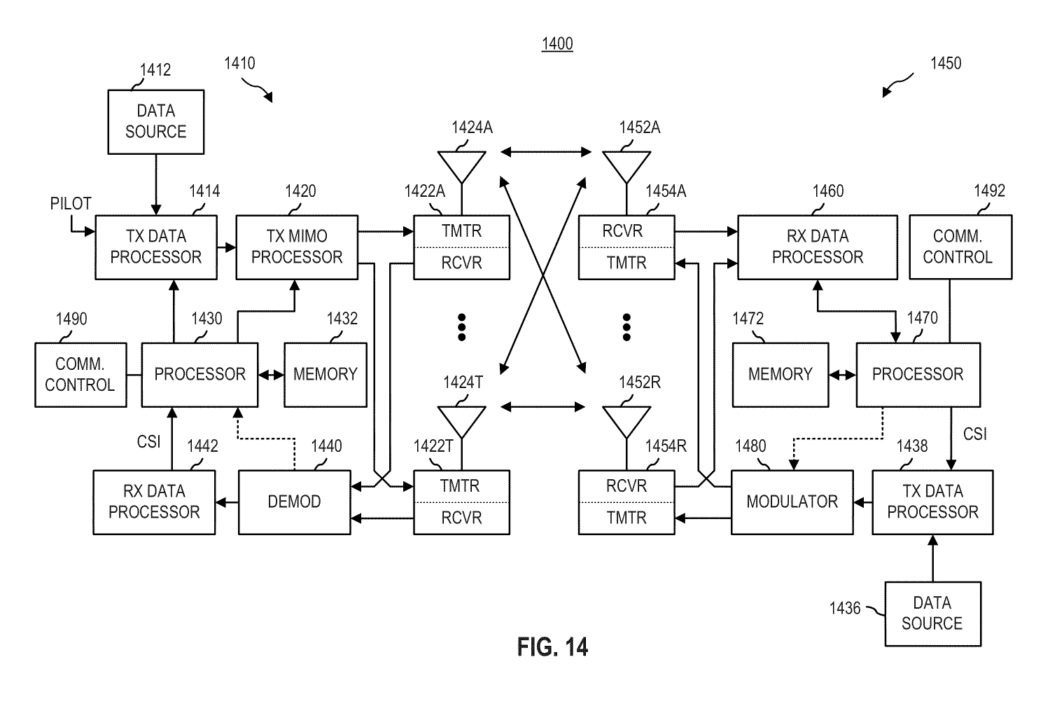

FIG. 14 illustrates a wireless device 1410 (e.g., an access point) and a wireless device 1450 (e.g., an access terminal) of a sample MIMO system 1400. At the device 1410, traffic data for a number of data streams is provided from a data source 1412 to a transmit (TX) data processor 1414. Each data stream may then be transmitted over a respective transmit antenna.

The TX data processor 1414 formats, codes, and interleaves the traffic data for each data stream based on a particular coding scheme selected for that data stream to provide coded data. The coded data for each data stream may be multiplexed with pilot data using OFDM techniques. The pilot data is typically a known data pattern that is processed in a known manner and may be used at the receiver system to estimate the channel response. The multiplexed pilot and coded data for each data stream is then modulated (i.e., symbol mapped) based on a particular modulation scheme (e.g., BPSK, QSPK, M-PSK, or M-QAM) selected for that data stream to provide modulation symbols. The data rate, coding, and modulation for each data stream may be determined by instructions performed by a processor 1430. A data memory 1432 may store program code, data, and other information used by the processor 1430 or other components of the device 1410.

The modulation symbols for all data streams are then provided to a TX MIMO processor 1420, which may further process the modulation symbols (e.g., for OFDM). The TX MIMO processor 1420 then provides N_{T} modulation symbol streams to N_{T} transceivers (XCVR) 1422A through 1422T. In some aspects, the TX MIMO processor 1420 applies beam-forming weights to the symbols of the data streams and to the antenna from which the symbol is being transmitted.

Each transceiver 1422 receives and processes a respective symbol stream to provide one or more analog signals, and further conditions (e.g., amplifies, filters, and upconverts) the analog signals to provide a modulated signal suitable for transmission over the MIMO channel. N_{T} modulated signals from transceivers 1422A through 1422T are then transmitted from N_{T} antennas 1424A through 1424T, respectively.

At the device 1450, the transmitted modulated signals are received by N_{R} antennas 1452A through 1452R and the received signal from each antenna 1452 is provided to a respective transceiver (XCVR) 1454A through 1454R. Each transceiver 1454 conditions (e.g., filters, amplifies, and downconverts) a respective received signal, digitizes the conditioned signal to provide samples, and further processes the samples to provide a corresponding “received” symbol stream.

A receive (RX) data processor 1460 then receives and processes the N_{R} received symbol streams from N_{R} transceivers 1454 based on a particular receiver processing technique to provide N_{T} “detected” symbol streams. The RX data processor 1460 then demodulates, deinterleaves, and decodes each detected symbol stream to recover the traffic data for the data stream. The processing by the RX data processor 1460 is complementary to that performed by the TX MIMO processor 1420 and the TX data processor 1414 at the device 1410.

A processor 1470 periodically determines which pre-coding matrix to use (discussed below). The processor 1470 formulates a reverse link message comprising a matrix index portion and a rank value portion. A data memory 1472 may store program code, data, and other information used by the processor 1470 or other components of the device 1450.

The reverse link message may comprise various types of information regarding the communication link and/or the received data stream. The reverse link message is then processed by a TX data processor 1438, which also receives traffic data for a number of data streams from a data source 1436, modulated by a modulator 1480, conditioned by the transceivers 1454A through 1454R, and transmitted back to the device 1410.

At the device 1410, the modulated signals from the device 1450 are received by the antennas 1424, conditioned by the transceivers 1422, demodulated by a demodulator (DEMOD) 1440, and processed by a RX data processor 1442 to extract the reverse link message transmitted by the device 1450. The processor 1430 then determines which pre-coding matrix to use for determining the beam-forming weights then processes the extracted message.

FIG. 14 also illustrates that the communication components may include one or more components that perform handover control operations as taught herein. For example, a communication (COMM.) control component 1490 may cooperate with the processor 1430 and/or other components of the device 1410 to manage communication operations associated with another device (e.g., device 1450) as taught herein. Similarly, a communication control component 1492 may cooperate with the processor 1470 and/or other components of the device 1450 to communicate with another device (e.g., device 1410). It should be appreciated that for each device 1410 and 1450 the functionality of two or more of the described components may be provided by a single component. For example, a single processing component may provide the functionality of the communication control component 1490 and the processor 1430 and a single processing component may provide the functionality of the communication control component 1492 and the processor 1470.

The teachings herein may be incorporated into various types of communication systems and/or system components. In some aspects, the teachings herein may be employed in a multiple-access system capable of supporting communication with multiple users by sharing the available system resources (e.g., by specifying one or more of bandwidth, transmit power, coding, interleaving, and so on). For example, the teachings herein may be applied to any one or combinations of the following technologies: Code Division Multiple Access (CDMA) systems, Multiple-Carrier CDMA (MCCDMA), Wideband CDMA (W-CDMA), High-Speed Packet Access (HSPA, HSPA+) systems, Time Division Multiple Access (TDMA) systems, Frequency Division Multiple Access (FDMA) systems, Single-Carrier FDMA (SC-FDMA) systems, Orthogonal Frequency Division Multiple Access (OFDMA) systems, or other multiple access techniques. A wireless communication system employing the teachings herein may be designed to implement one or more standards, such as IS-95, cdma2000, IS-856, W-CDMA, TDSCDMA, and other standards. A CDMA network may implement a radio technology such as Universal Terrestrial Radio Access (UTRA), cdma2000, or some other technology. UTRA includes W-CDMA and Low Chip Rate (LCR). The cdma2000 technology covers IS-2000, IS-95 and IS-856 standards. A TDMA network may implement a radio technology such as Global System for Mobile Communication (GSM). An OFDMA network may implement a radio technology such as Evolved UTRA (E-UTRA), IEEE 802.11, IEEE 802.16, IEEE 802.20, Flash-OFDM®, etc. UTRA, E-UTRA, and GSM are part of Universal Mobile Telecommunication System (UMTS). The teachings herein may be implemented in a 3GPP Long Term Evolution (LTE) system, an Ultra-Mobile Broadband (UMB) system, and other types of systems. LTE is a release of UMTS that uses E-UTRA. UTRA, E-UTRA, GSM, UMTS and LTE are described in documents from an organization named “3rd Generation Partnership Project” (3GPP), while cdma2000 is described in documents from an organization named “3rd Generation Partnership Project 2” (3GPP2). Although certain aspects of the disclosure may be described using 3GPP terminology, it is to be understood that the teachings herein may be applied to 3GPP (e.g., Rel99, Rel5, Rel6, Rel7) technology, as well as 3GPP2 (e.g., 1xRTT, 1xEV-DO Rel0, RevA, RevB) technology and other technologies.

The teachings herein may be incorporated into (e.g., implemented within or performed by) a variety of apparatuses (e.g., nodes). In some aspects, a node (e.g., a wireless node) implemented in accordance with the teachings herein may comprise an access point or an access terminal.

For example, an access terminal may comprise, be implemented as, or known as user equipment, a subscriber station, a subscriber unit, a mobile station, a mobile, a mobile node, a remote station, a remote terminal, a user terminal, a user agent, a user device, or some other terminology. In some implementations, an access terminal may comprise a cellular telephone, a cordless telephone, a session initiation protocol (SIP) phone, a wireless local loop (WLL) station, a personal digital assistant (PDA), a handheld device having wireless connection capability, or some other suitable processing device connected to a wireless modem. Accordingly, one or more aspects taught herein may be incorporated into a phone (e.g., a cellular phone or smart phone), a computer (e.g., a laptop), a portable communication device, a portable computing device (e.g., a personal data assistant), an entertainment device (e.g., a music device, a video device, or a satellite radio), a global positioning system device, or any other suitable device that is configured to communicate via a wireless medium.

An access point may comprise, be implemented as, or known as a NodeB, an eNodeB, a radio network controller (RNC), a base station (BS), a radio base station (RBS), a base station controller (BSC), a base transceiver station (BTS), a transceiver function (TF), a radio transceiver, a radio router, a basic service set (BSS), an extended service set (ESS), a macro cell, a macro node, a Home eNB (HeNB), a femto cell, a femto node, a pico node, or some other similar terminology.

In some aspects, a node (e.g., an access point) may comprise an access node for a communication system. Such an access node may provide, for example, connectivity for or to a network (e.g., a wide area network such as the Internet or a cellular network) via a wired or wireless communication link to the network. Accordingly, an access node may enable another node (e.g., an access terminal) to access a network or some other functionality. In addition, it should be appreciated that one or both of the nodes may be portable or, in some cases, relatively non-portable.

Also, it should be appreciated that a wireless node may be capable of transmitting and/or receiving information in a non-wireless manner (e.g., via a wired connection). Thus, a receiver and a transmitter as discussed herein may include appropriate communication interface components (e.g., electrical or optical interface components) to communicate via a non-wireless medium.

A wireless node may communicate via one or more wireless communication links that are based on or otherwise support any suitable wireless communication technology. For example, in some aspects a wireless node may associate with a network. In some aspects, the network may comprise a local area network or a wide area network. A wireless device may support or otherwise use one or more of a variety of wireless communication technologies, protocols, or standards such as those discussed herein (e.g., CDMA, TDMA, OFDM, OFDMA, WiMAX, Wi-Fi, and so on). Similarly, a wireless node may support or otherwise use one or more of a variety of corresponding modulation or multiplexing schemes. A wireless node may thus include appropriate components (e.g., air interfaces) to establish and communicate via one or more wireless communication links using the above or other wireless communication technologies. For example, a wireless node may comprise a wireless transceiver with associated transmitter and receiver components that may include various components (e.g., signal generators and signal processors) that facilitate communication over a wireless medium.

The functionality described herein (e.g., with regard to one or more of the accompanying figures) may correspond in some aspects to similarly designated “means for” functionality in the appended claims.

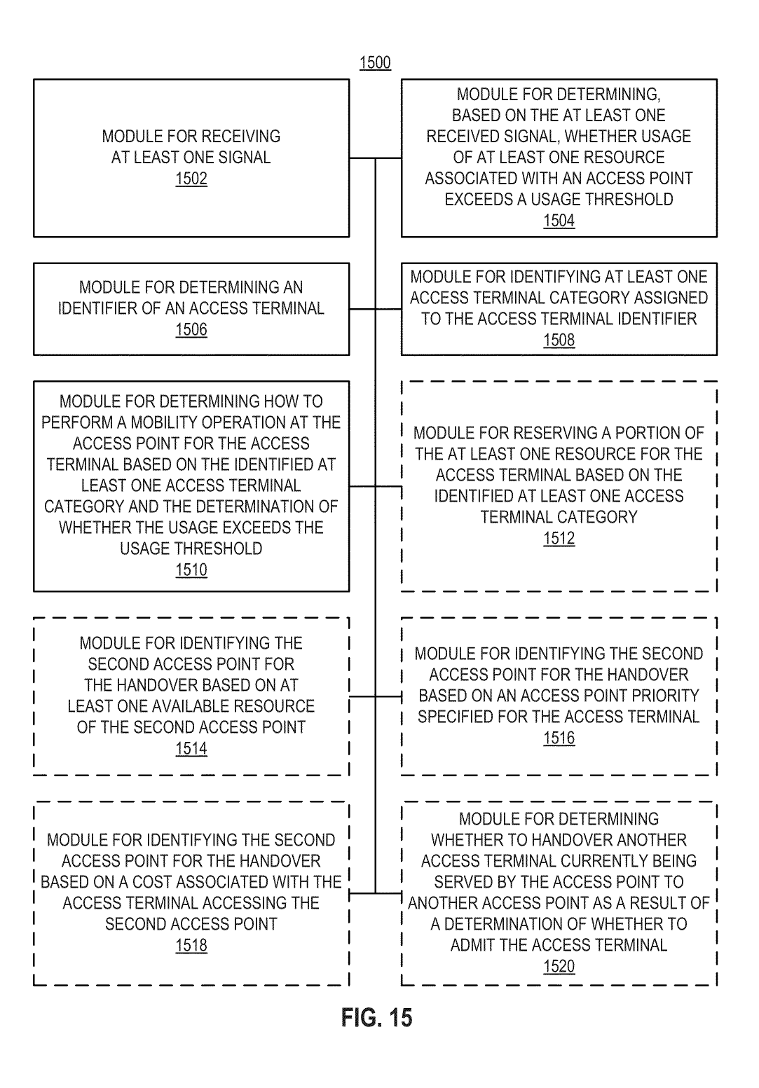

Referring to FIG. 15, an apparatus 1500 is represented as a series of interrelated functional modules. A module for (e.g., means for) receiving at least one signal 1502 may correspond at least in some aspects to, for example, a communication component as discussed herein. A module for (e.g., means for) determining, based on the at least one received signal, whether usage of at least one resource associated with an access point exceeds a usage threshold 1504 may correspond at least in some aspects to, for example, a processing system as discussed herein. A module for (e.g., means for) determining an identifier of an access terminal 1506 may correspond at least in some aspects to, for example, a processing system as discussed herein. A module for (e.g., means for) identifying at least one access terminal category assigned to the access terminal identifier 1508 may correspond at least in some aspects to, for example, a processing system as discussed herein. A module for (e.g., means for) determining how to perform a mobility operation at the access point for the access terminal based on the identified at least one access terminal category and the determination of whether the usage exceeds the usage threshold 1510 may correspond at least in some aspects to, for example, a processing system as discussed herein. A module for (e.g., means for) reserving a portion of the at least one resource for the access terminal based on the identified at least one access terminal category 1512 may correspond at least in some aspects to, for example, a processing system as discussed herein. A module for (e.g., means for) identifying the second access point for the handover based on at least one available resource of the second access point 1514 may correspond at least in some aspects to, for example, a processing system as discussed herein. A module for (e.g., means for) identifying the second access point for the handover based on an access point priority specified for the access terminal 1516 may correspond at least in some aspects to, for example, a processing system as discussed herein. A module for (e.g., means for) identifying the second access point for the handover based on a cost associated with the access terminal accessing the second access point 1518 may correspond at least in some aspects to, for example, a processing system as discussed herein. A module for (e.g., means for) determining whether to handover another access terminal currently being served by the access point to another access point as a result of a determination of whether to admit the access terminal 1520 may correspond at least in some aspects to, for example, a processing system as discussed herein.

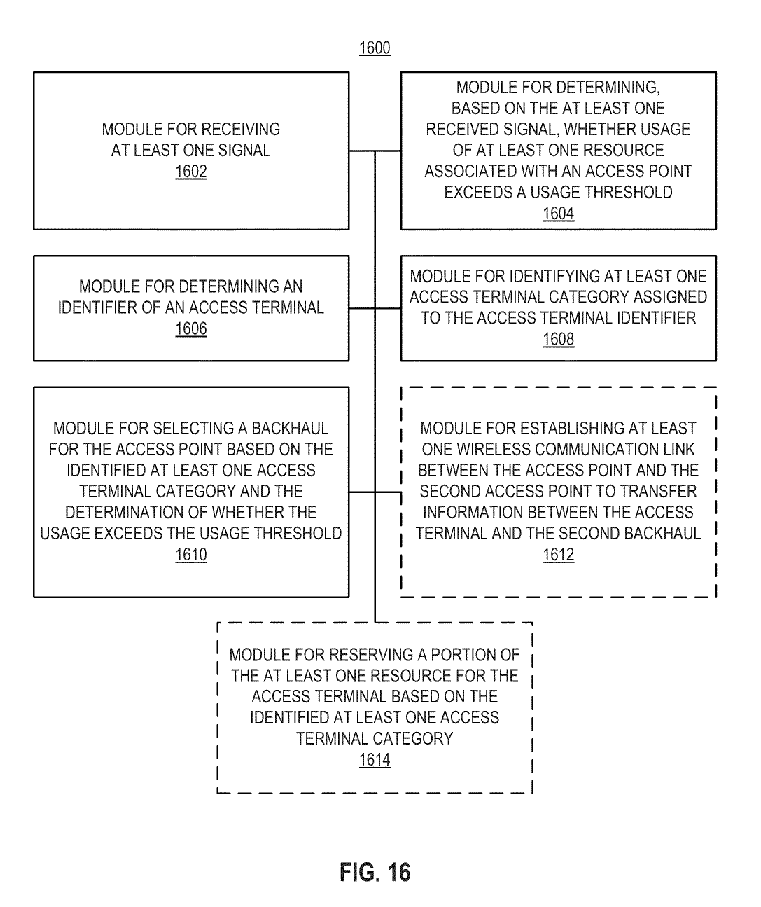

Referring to FIG. 16, an apparatus 1600 is represented as a series of interrelated functional modules. A module for (e.g., means for) receiving at least one signal 1602 may correspond at least in some aspects to, for example, a communication component as discussed herein. A module for (e.g., means for) determining, based on the at least one received signal, whether usage of at least one resource associated with an access point exceeds a usage threshold 1604 may correspond at least in some aspects to, for example, a processing system as discussed herein. A module for (e.g., means for) determining an identifier of an access terminal 1606 may correspond at least in some aspects to, for example, a processing system as discussed herein. A module for (e.g., means for) identifying at least one access terminal category assigned to the access terminal identifier 1608 may correspond at least in some aspects to, for example, a processing system as discussed herein. A module for (e.g., means for) selecting a backhaul for the access point based on the identified at least one access terminal category and the determination of whether the usage exceeds the usage threshold 1610 may correspond at least in some aspects to, for example, a processing system as discussed herein. A module for (e.g., means for) establishing at least one wireless communication link between the access point and the second access point to transfer information between the access terminal and the second backhaul 1612 may correspond at least in some aspects to, for example, a processing system as discussed herein. A module for (e.g., means for) reserving a portion of the at least one resource for the access terminal based on the identified at least one access terminal category 1614 may correspond at least in some aspects to, for example, a processing system as discussed herein.

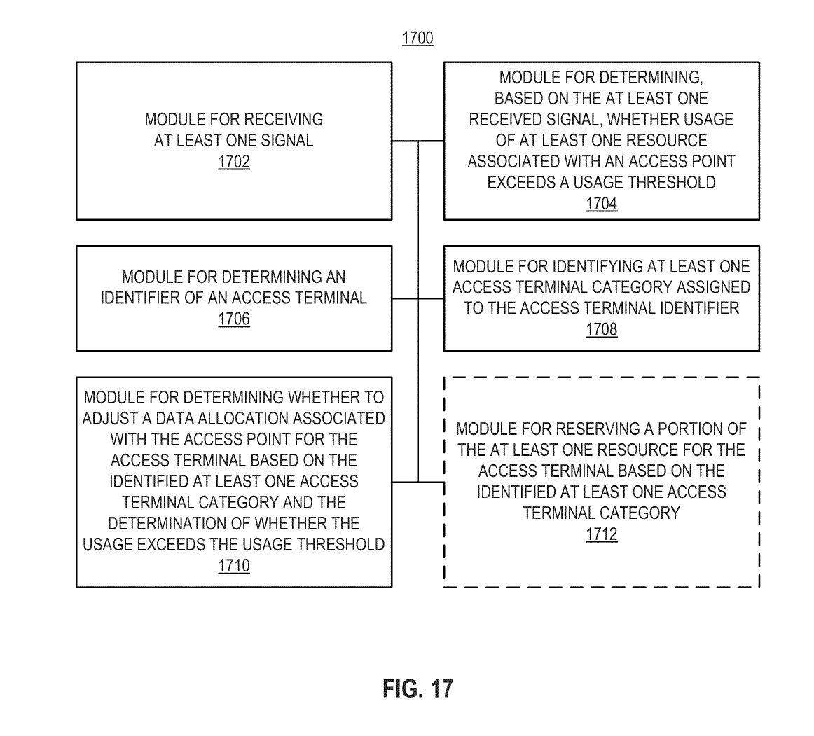

Referring to FIG. 17, an apparatus 1700 is represented as a series of interrelated functional modules. A module for (e.g., means for) receiving at least one signal 1702 may correspond at least in some aspects to, for example, a communication component as discussed herein. A module for (e.g., means for) determining, based on the at least one received signal, whether usage of at least one resource associated with an access point exceeds a usage threshold 1704 may correspond at least in some aspects to, for example, a processing system as discussed herein. A module for (e.g., means for) determining an identifier of an access terminal 1706 may correspond at least in some aspects to, for example, a processing system as discussed herein. A module for (e.g., means for) identifying at least one access terminal category assigned to the access terminal identifier 1708 may correspond at least in some aspects to, for example, a processing system as discussed herein. A module for (e.g., means for) determining whether to adjust a data allocation associated with the access point for the access terminal based on the identified at least one access terminal category and the determination of whether the usage exceeds the usage threshold 1710 may correspond at least in some aspects to, for example, a processing system as discussed herein. A module for (e.g., means for) reserving a portion of the at least one resource for the access terminal based on the identified at least one access terminal category 1712 may correspond at least in some aspects to, for example, a processing system as discussed herein.

The functionality of the modules of FIGS. 15-17 may be implemented in various ways consistent with the teachings herein. In some aspects, the functionality of these modules may be implemented as one or more electrical components. In some aspects, the functionality of these blocks may be implemented as a processing system including one or more processor components. In some aspects, the functionality of these modules may be implemented using, for example, at least a portion of one or more integrated circuits (e.g., an ASIC). As discussed herein, an integrated circuit may include a processor, software, other related components, or some combination thereof. Thus, the functionality of different modules may be implemented, for example, as different subsets of an integrated circuit, as different subsets of a set of software modules, or a combination thereof. Also, it should be appreciated that a given subset (e.g., of an integrated circuit and/or of a set of software modules) may provide at least a portion of the functionality for more than one module. The functionality of these modules also may be implemented in some other manner as taught herein. In some aspects one or more of any dashed blocks in FIGS. 15-17 are optional.

In addition, the components and functions represented by FIGS. 15-17 as well as other components and functions described herein, may be implemented using any suitable means. Such means also may be implemented, at least in part, using corresponding structure as taught herein. For example, the components described above in conjunction with the “module for” components of FIGS. 15-17 also may correspond to similarly designated “means for” functionality. Thus, in some aspects one or more of such means may be implemented using one or more of processor components, integrated circuits, or other suitable structure as taught herein.

In some aspects, an apparatus or any component of an apparatus may be configured to (or operable to or adapted to) provide functionality as taught herein. This may be achieved, for example: by manufacturing (e.g., fabricating) the apparatus or component so that it will provide the functionality; by programming the apparatus or component so that it will provide the functionality; or through the use of some other suitable implementation technique.

It should be understood that any reference to an element herein using a designation such as “first,” “second,” and so forth does not generally limit the quantity or order of those elements. Rather, these designations may be used herein as a convenient method of distinguishing between two or more elements or instances of an element. Thus, a reference to first and second elements does not mean that only two elements may be employed there or that the first element must precede the second element in some manner. Also, unless stated otherwise a set of elements may comprise one or more elements. In addition, terminology of the form “at least one of A, B, or C” or “one or more of A, B, or C” or “at least one of the group consisting of A, B, and C” used in the description or the claims means “A or B or C or any combination of these elements.” For example, this terminology may include A, or B, or C, or A and B, or A and C, or A and B and C, or 2A, or 2B, or 2C, and so on.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that any of the various illustrative logical blocks, modules, processors, means, circuits, and algorithm steps described in connection with the aspects disclosed herein may be implemented as electronic hardware (e.g., a digital implementation, an analog implementation, or a combination of the two, which may be designed using source coding or some other technique), various forms of program or design code incorporating instructions (which may be referred to herein, for convenience, as “software” or a “software module”), or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the aspects disclosed herein may be implemented within or performed by a processing system, an integrated circuit (“IC”), an access terminal, or an access point. A processing system may be implemented using one or more ICs or may be implemented within an IC (e.g., as part of a system on a chip). An IC may comprise a general purpose processor, a digital signal processor (DSP), an application specific integrated circuit (ASIC), a field programmable gate array (FPGA) or other programmable logic device, discrete gate or transistor logic, discrete hardware components, electrical components, optical components, mechanical components, or any combination thereof designed to perform the functions described herein, and may execute codes or instructions that reside within the IC, outside of the IC, or both. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

It is understood that any specific order or hierarchy of steps in any disclosed process is an example of a sample approach. Based upon design preferences, it is understood that the specific order or hierarchy of steps in the processes may be rearranged while remaining within the scope of the present disclosure. The accompanying method claims present elements of the various steps in a sample order, and are not meant to be limited to the specific order or hierarchy presented.

In one or more exemplary embodiments, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A computer-readable media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Thus, in some aspects computer readable medium may comprise non-transitory computer-readable medium (e.g., tangible media, computer-readable storage media, etc.). In addition, in some aspects computer-readable medium may comprise transitory computer readable medium (e.g., comprising a signal). Combinations of the above should also be included within the scope of computer-readable media. It should be appreciated that a computer-readable medium may be implemented in any suitable computer-program product.

As used herein, the term “determining” encompasses a wide variety of actions. For example, “determining” may include calculating, computing, processing, deriving, investigating, looking up (e.g., looking up in a table, a database or another data structure), ascertaining, and the like. Also, “determining” may include receiving (e.g., receiving information), accessing (e.g., accessing data in a memory), and the like. Also, “determining” may include resolving, selecting, choosing, establishing, and the like.

The previous description of the disclosed aspects is provided to enable any person skilled in the art to make or use the present disclosure. Various modifications to these aspects will be readily apparent to those skilled in the art, and the generic principles defined herein may be applied to other aspects without departing from the scope of the disclosure. Thus, the present disclosure is not intended to be limited to the aspects shown herein but is to be accorded the widest scope consistent with the principles and novel features disclosed herein.

What is claimed is:

1. An apparatus for communication, comprising:
a communication component configured to receive at least one signal; and
a processing system configured to:
determine, based on the at least one received signal, whether usage of at least one resource associated with an access point exceeds a usage threshold,
determine an identifier of an access terminal,
identify at least one access terminal category assigned to the access terminal identifier, and
determine how to perform a mobility operation at the access point for the access terminal based on the identified at least one access terminal category and the determination of whether the usage exceeds the usage threshold.

2. The apparatus of claim 1, wherein the at least one resource comprises at least one of: backhaul bandwidth used, backhaul capacity, channel element, resource cost, data throttling limit, over-the-air bandwidth used, over-the-air capacity, transmit power, memory resource, downlink load, or uplink load.

3. The apparatus of claim 1, wherein the at least one access terminal category is indicative of at least one of: access terminal priority, access terminal ownership, access terminal group membership, access terminal class type, access terminal payment plan, or access terminal provisioning.

4. The apparatus of claim 1, wherein the processing system is further configured to reserve a portion of the at least one resource for the access terminal based on the identified at least one access terminal category.

5. The apparatus of claim 1, wherein the determination of how to perform the mobility operation comprises determining whether to hand-over the access terminal to a second access point.

6. The apparatus of claim 5, wherein the processing system is further configured to identify the second access point for the handover based on at least one available resource of the second access point.

7. The apparatus of claim 5, wherein the processing system is further configured to identify the second access point for the handover based on an access point priority specified for the access terminal.

8. The apparatus of claim 5, wherein the processing system is further configured to identify the second access point for the handover based on a cost associated with the access terminal accessing the second access point.

9. The apparatus of claim 5, wherein:
the access terminal is served by the access point via a first wireless communication technology; and
the second access point provides service for the handover via a second wireless communication technology.

10. The apparatus of claim 1, wherein the determination of how to perform the mobility operation comprises determining whether to adjust a mobility parameter at the access point for the access terminal.

11. The apparatus of claim 10, wherein the mobility parameter comprises a handover parameter.

12. The apparatus of claim 11, wherein the handover parameter comprises a connected mode handout parameter.

13. The apparatus of claim 10, wherein the mobility parameter comprises a reselection parameter.

14. The apparatus of claim 10, wherein the mobility parameter comprises a soft handover threshold.

15. The apparatus of claim 1, wherein the determination of how to perform the mobility operation comprises determining whether to admit the access terminal for service from the access point.

16. The apparatus of claim 15, wherein the processing system is further configured to determine whether to handover another access terminal currently being served by the access point to another access point as a result of the determination of whether to admit the access terminal.

17. The apparatus of claim 15, wherein the determination of whether to admit the access terminal is further based on a quantity of times that the access terminal has been admitted to and handed-over from the access point over a defined period of time.

18. The apparatus of claim 1, wherein the access point comprises a femtocell.

19. A method of communication, comprising:
receiving at least one signal;
determining, based on the at least one received signal, whether usage of at least one resource associated with an access point exceeds a usage threshold;
determining an identifier of an access terminal;
identifying at least one access terminal category assigned to the access terminal identifier; and
determining how to perform a mobility operation at the access point for the access terminal based on the identified at least one access terminal category and the determination of whether the usage exceeds the usage threshold.

20. The method of claim 19, wherein the at least one resource comprises at least one of: backhaul bandwidth used, backhaul capacity, channel element, resource cost, data throttling limit, over-the-air bandwidth used, over-the-air capacity, transmit power, memory resource, downlink load, or uplink load.

21. The method of claim 19, wherein the at least one access terminal category is indicative of at least one of: access terminal priority, access terminal ownership, access terminal group membership, access terminal class type, access terminal payment plan, or access terminal provisioning.

22. The method of claim 19, further comprising reserving a portion of the at least one resource for the access terminal based on the identified at least one access terminal category.

23. The method of claim 19, wherein the determination of how to perform the mobility operation comprises determining whether to hand-over the access terminal to a second access point.

24. The method of claim 23, further comprising identifying the second access point for the handover based on at least one available resource of the second access point.

25. The method of claim 23, further comprising identifying the second access point for the handover based on an access point priority specified for the access terminal.

26. The method of claim 23, further comprising identifying the second access point for the handover based on a cost associated with the access terminal accessing the second access point.

27. The method of claim 23, wherein:
the access terminal is served by the access point via a first wireless communication technology; and
the second access point provides service for the handover via a second wireless communication technology.

28. The method of claim 19, wherein the determination of how to perform the mobility operation comprises determining whether to adjust a mobility parameter at the access point for the access terminal.

29. The method of claim 28, wherein the mobility parameter comprises a handover parameter.

30. The method of claim 29, wherein the handover parameter comprises a connected mode handout parameter.

31. The method of claim 28, wherein the mobility parameter comprises a reselection parameter.

32. The method of claim 28, wherein the mobility parameter comprises a soft handover threshold.

33. The method of claim 19, wherein the determination of how to perform the mobility operation comprises determining whether to admit the access terminal for service from the access point.

34. The method of claim 33, further comprising determining whether to handover another access terminal currently being served by the access point to another access point as a result of the determination of whether to admit the access terminal.

35. The method of claim 33, wherein the determination of whether to admit the access terminal is further based on a quantity of times that the access terminal has been admitted to and handed-over from the access point over a defined period of time.

36. The method of claim 19, wherein the access point comprises a femtocell.

37. An apparatus for communication, comprising:
means for receiving at least one signal;
means for determining, based on the at least one received signal, whether usage of at least one resource associated with an access point exceeds a usage threshold;
means for determining an identifier of an access terminal;
means for identifying at least one access terminal category assigned to the access terminal identifier; and
means for determining how to perform a mobility operation at the access point for the access terminal based on the identified at least one access terminal category and the determination of whether the usage exceeds the usage threshold.

38. The apparatus of claim 37, wherein the determination of how to perform the mobility operation comprises determining whether to hand-over the access terminal to a second access point.

39. The apparatus of claim 37, wherein the determination of how to perform the mobility operation comprises determining whether to adjust a mobility parameter at the access point for the access terminal.

40. The apparatus of claim 37, wherein the determination of how to perform the mobility operation comprises determining whether to admit the access terminal for service from the access point.

41. A computer-program product, comprising:
computer-readable medium comprising code for causing a computer to:
receive at least one signal;
determine, based on the at least one received signal, whether usage of at least one resource associated with an access point exceeds a usage threshold;
determine an identifier of an access terminal;
identify at least one access terminal category assigned to the access terminal identifier; and
determine how to perform a mobility operation at the access point for the access terminal based on the identified at least one access terminal category and the determination of whether the usage exceeds the usage threshold.

42. The computer-program product of claim 41, wherein the determination of how to perform the mobility operation comprises determining whether to hand-over the access terminal to a second access point.

43. The computer-program product of claim 41, wherein the determination of how to perform the mobility operation comprises determining whether to adjust a mobility parameter at the access point for the access terminal.

44. The computer-program product of claim 41, wherein the determination of how to perform the mobility operation comprises determining whether to admit the access terminal for service from the access point.

45. An apparatus for communication, comprising:
a communication component configured to receive at least one signal; and
a processing system configured to:
determine, based on the at least one received signal, whether usage of at least one resource associated with an access point exceeds a usage threshold,
determine an identifier of an access terminal,
identify at least one access terminal category assigned to the access terminal identifier, and
select a backhaul for the access point based on the identified at least one access terminal category and the determination of whether the usage exceeds the usage threshold.

46. The apparatus of claim 45, wherein the selection of the backhaul comprises switching from a first backhaul associated with the access point to a second backhaul associated with a second access point.

47. The apparatus of claim 46, wherein the processing system is further configured to establish at least one wireless communication link between the access point and the second access point to transfer information between the access terminal and the second backhaul.

48. The apparatus of claim 45, wherein the selection of the backhaul comprises selecting a user plane attach point.

49. The apparatus of claim 48, wherein the selection of the user plane attach point comprises switching from a first user plane attach point associated with the access point to a second user plane attach point associated with a second access point.

50. The apparatus of claim 45, wherein the at least one resource comprises at least one of: backhaul bandwidth used, backhaul capacity, channel element, resource cost, data throttling limit, over-the-air bandwidth used, over-the-air capacity, transmit power, memory resource, downlink load, or uplink load.

51. The apparatus of claim 45, wherein the at least one access terminal category is indicative of at least one of: access terminal priority, access terminal ownership, access terminal group membership, access terminal class type, access terminal payment plan, or access terminal provisioning.

52. The apparatus of claim 45, wherein the processing system is further configured to reserve a portion of the at least one resource for the access terminal based on the identified at least one access terminal category.

53. The apparatus of claim 45, wherein the access point comprises a femtocell.

54. A method of communication, comprising:
receiving at least one signal;
determining, based on the at least one received signal, whether usage of at least one resource associated with an access point exceeds a usage threshold;
determining an identifier of an access terminal;
identifying at least one access terminal category assigned to the access terminal identifier; and
selecting a backhaul for the access point based on the identified at least one access terminal category and the determination of whether the usage exceeds the usage threshold.

55. The method of claim 54, wherein the selection of the backhaul comprises switching from a first backhaul associated with the access point to a second backhaul associated with a second access point.

56. The method of claim 55, further comprising establishing at least one wireless communication link between the access point and the second access point to transfer information between the access terminal and the second backhaul.

57. The method of claim 54, wherein the selection of the backhaul comprises selecting a user plane attach point.

58. The method of claim 57, wherein the selection of the user plane attach point comprises switching from a first user plane attach point associated with the access point to a second user plane attach point associated with a second access point.

59. The method of claim 54, wherein the at least one resource comprises at least one of: backhaul bandwidth used, backhaul capacity, channel element, resource cost, data throttling limit, over-the-air bandwidth used, over-the-air capacity, transmit power, memory resource, downlink load, or uplink load.

60. The method of claim 54, wherein the at least one access terminal category is indicative of at least one of: access terminal priority, access terminal ownership, access terminal group membership, access terminal class type, access terminal payment plan, or access terminal provisioning.

61. The method of claim 54, further comprising reserving a portion of the at least one resource for the access terminal based on the identified at least one access terminal category.

62. The method of claim 54, wherein the access point comprises a femtocell.

63. An apparatus for communication, comprising:
means for receiving at least one signal;
means for determining, based on the at least one received signal, whether usage of at least one resource associated with an access point exceeds a usage threshold;
means for determining an identifier of an access terminal;
means for identifying at least one access terminal category assigned to the access terminal identifier; and
means for selecting a backhaul for the access point based on the identified at least one access terminal category and the determination of whether the usage exceeds the usage threshold.

64. The apparatus of claim 63, wherein the selection of the backhaul comprises switching from a first backhaul associated with the access point to a second backhaul associated with a second access point.

65. The apparatus of claim 63, wherein the selection of the backhaul comprises selecting a user plane attach point.

66. A computer-program product, comprising:
computer-readable medium comprising code for causing a computer to:
receive at least one signal;
determine, based on the at least one received signal, whether usage of at least one resource associated with an access point exceeds a usage threshold;
determine an identifier of an access terminal;
identify at least one access terminal category assigned to the access terminal identifier; and
select a backhaul for the access point based on the identified at least one access terminal category and the determination of whether the usage exceeds the usage threshold.

67. The computer-program product of claim 66, wherein the selection of the backhaul comprises switching from a first backhaul associated with the access point to a second backhaul associated with a second access point.

68. The computer-program product of claim 66, wherein the selection of the backhaul comprises selecting a user plane attach point.

69. An apparatus for communication, comprising:
a communication component configured to receive at least one signal; and
a processing system configured to:
determine, based on the at least one received signal, whether usage of at least one resource associated with an access point exceeds a usage threshold,
determine an identifier of an access terminal,
identify at least one access terminal category assigned to the access terminal identifier, and
determine whether to adjust a data allocation associated with the access point for the access terminal based on the identified at least one access terminal category and the determination of whether the usage exceeds the usage threshold.

70. The apparatus of claim 69, wherein the adjustment of the data allocation comprises adjusting traffic load on a downlink.

71. The apparatus of claim 69, wherein the adjustment of the data allocation comprises adjusting traffic load on an uplink.

72. The apparatus of claim 69, wherein the at least one resource comprises at least one of: backhaul bandwidth used, backhaul capacity, channel element, resource cost, data throttling limit, over-the-air bandwidth used, over-the-air capacity, transmit power, memory resource, downlink load, or uplink load.

73. The apparatus of claim 69, wherein the at least one access terminal category is indicative of at least one of: access terminal priority, access terminal ownership, access terminal group membership, access terminal class type, access terminal payment plan, or access terminal provisioning.

74. The apparatus of claim 69, wherein the processing system is further configured to reserve a portion of the at least one resource for the access terminal based on the identified at least one access terminal category.

75. The apparatus of claim 69, wherein the access point comprises a femtocell.

76. A method of communication, comprising:
receiving at least one signal;
determining, based on the at least one received signal, whether usage of at least one resource associated with an access point exceeds a usage threshold;
determining an identifier of an access terminal;
identifying at least one access terminal category assigned to the access terminal identifier; and
determining whether to adjust a data allocation associated with the access point for the access terminal based on the identified at least one access terminal category and the determination of whether the usage exceeds the usage threshold.

77. The method of claim 76, wherein the adjustment of the data allocation comprises adjusting traffic load on a downlink.

78. The method of claim 76, wherein the adjustment of the data allocation comprises adjusting traffic load on an uplink.

79. The method of claim 76, wherein the at least one resource comprises at least one of: backhaul bandwidth used, backhaul capacity, channel element, resource cost, data throttling limit, over-the-air bandwidth used, over-the-air capacity, transmit power, memory resource, downlink load, or uplink load.

80. The method of claim 76, wherein the at least one access terminal category is indicative of at least one of: access terminal priority, access terminal ownership, access terminal group membership, access terminal class type, access terminal payment plan, or access terminal provisioning.

81. The method of claim 76, further comprising reserving a portion of the at least one resource for the access terminal based on the identified at least one access terminal category.

82. The method of claim 76, wherein the access point comprises a femtocell.

83. An apparatus for communication, comprising:
means for receiving at least one signal;
means for determining, based on the at least one received signal, whether usage of at least one resource associated with an access point exceeds a usage threshold;
means for determining an identifier of an access terminal;
means for identifying at least one access terminal category assigned to the access terminal identifier; and
means for determining whether to adjust a data allocation associated with the access point for the access terminal based on the identified at least one access terminal category and the determination of whether the usage exceeds the usage threshold.

84. The apparatus of claim 83, wherein the adjustment of the data allocation comprises adjusting traffic load on a downlink.

85. The apparatus of claim 83, wherein the adjustment of the data allocation comprises adjusting traffic load on an uplink.

86. A computer-program product, comprising:
computer-readable medium comprising code for causing a computer to:
receive at least one signal;
determine, based on the at least one received signal, whether usage of at least one resource associated with an access point exceeds a usage threshold;
determine an identifier of an access terminal;
identify at least one access terminal category assigned to the access terminal identifier; and
determine whether to adjust a data allocation associated with the access point for the access terminal based on the identified at least one access terminal category and the determination of whether the usage exceeds the usage threshold.

87. The computer-program product of claim 86, wherein the adjustment of the data allocation comprises adjusting traffic load on a downlink.

88. The computer-program product of claim 86, wherein the adjustment of the data allocation comprises adjusting traffic load on an uplink.
